(19) United States
(12) Patent Application Publication
(10) Pub. No.: US 2026/0291824 A1
(43) Pub. Date: Sep. 24, 2026

(54) METHODS FOR DISCOVERY AND SIGNALING PROCEDURE FOR CLUSTERED AND PEER-TO-PEER FEDERATED LEARNING

(71) Applicant: QUALCOMM Incorporated, San Diego, CA (US)

(72) Inventors: Mahmoud ASHOUR, San Diego, CA (US); Kyle Chi GUAN, New York, NY (US); Anantharaman BALASUBRAMANIAN, San Diego, CA (US); Kapil GULATI, Belle Mead, NJ (US); Himaja KESAVAREDDIGARI, Bridgewater, NJ (US); Hui GUO, Beijing (CN); Lan YU, Beijing (CN)

(21) Appl. No.: 18/881,238

(22) PCT Filed: Aug. 19, 2022
(86) PCT No.: PCT/CN2022/113551

§ 371 Date: Jan. 3, 2025

(51) Int. Cl. H04L 41/16; H04W 8/00

(52) U.S. Cl. CPC H04L 41/16; H04W 8/005

(57) ABSTRACT

Aspects are provided which allow a UE to discover other network nodes and perform ML model training in a clustered FL or peer-to-peer FL environment through various signaling procedures between the UE and the network node(s). The UE provides a first message including first FL information of the apparatus to a network node. The UE obtains a second message including second FL information of the network node. The UE then provides a ML model information update to the network node based on the first FL information and the second FL information. As a result, ML model training may be achieved in a distributed manner using clustered FL or peer-to-peer FL with minimization or avoidance of bottlenecks, communication overhead, challenges to model training due to heterogeneity of computational resources, training data, training tasks, or associated ML models, security and privacy challenges, or other limitations associated with conventional FL.

### BACKGROUND

### Technical Field

The present disclosure generally relates to communication systems, and more particularly, to wireless communication systems among user equipment (UEs) for clustered and peer-to-peer federated learning.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

For example, some aspects of wireless communication include direct communication between devices, such as device-to-device (D2D), vehicle-to-everything (V2X), and the like. There exists a need for further improvements in such direct communication between devices. Improvements related to direct communication between devices may be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The apparatus includes a processor, and memory coupled with the processor. The processor is configured to provide a first message including first federated learning (FL) information of the apparatus to a network node, to obtain a second message including second FL information of the network node; and to provide a machine learning (ML) model information update to the network node based on the first FL information and the second FL information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 illustrate example aspects of a sidelink slot structure.

FIG. 4 is a diagram illustrating an example of a first device and a second device involved in wireless communication based, e.g., on sidelink communication.

FIG. 5 is a conceptual diagram of an example Open Radio Access Network architecture.

FIG. 6 is a diagram illustrating an example of a neural network.

FIG. 7 is a diagram illustrating an example of an FL architecture.

FIGS. 8A and 8B are diagrams illustrating examples of an FL architecture in different applications.

FIG. 9 is a diagram illustrating an example of a clustered FL architecture.

FIG. 10 is a diagram illustrating an example of a peer-to-peer FL architecture.

FIG. 11 is a diagram illustrating an example of a signaling procedure for neighbor discovery.

FIG. 12 is a diagram illustrating an example of another signaling procedure for neighbor discovery.

FIG. 13 is a diagram illustrating an example of a node state machine during a cluster formation or leader election process.

FIG. 14 is a diagram illustrating an example of a signaling procedure for simultaneous discovery and cluster formation.

FIG. 15 is a diagram illustrating an example of a signaling procedure for intra-cluster FL or peer-to-peer FL following election or nomination of a leader node.

FIG. 16 is a diagram illustrating an example of a signaling procedure for inter-cluster FL following one or more iterations of intra-cluster FL.

FIG. 17 is a diagram illustrating an example of a signaling procedure for synchronous peer-to-peer FL without nomination or election of a leader node.

FIG. 18 is a diagram illustrating an example of a signaling procedure for asynchronous peer-to-peer FL without nomination or election of a leader node.

FIGS. 19A-19D are a flowchart of a method of wireless communication.

FIG. 20 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Federated learning (FL) refers to a distributed machine learning technique in which multiple decentralized nodes holding local data samples may train a global machine learning (ML) model (e.g., a classifier, a navigation system recommendation system, a digital assistant, a diagnostic system, or other model applied by multiple network nodes) without exchanging the data samples themselves between nodes to perform the training. An FL framework includes multiple network nodes or entities, namely a centralized aggregation server and participating FL devices (i.e., participants or nodes such as UEs). In one aspect or implementation, the FL framework enables the FL devices to learn a global ML model by allowing for the passing of messages among the devices through the central aggregation server or coordinator (also referred to throughout this disclosure as an FL parameter server), which may be configured to communicate with the various FL devices and coordinate the learning framework. Nodes in the FL environment may process their own datasets and perform local updates to the global ML model, and the central server may aggregate the local updates and provide an updated global ML model to the nodes for further training or predictions.

However, conventional FL architectures rely on a centralized server to create, aggregate, and refine a global ML model for participating nodes, thus necessitating the transmission of updates based on locally trained ML models from participating nodes to the server during an FL iteration. This centralized approach to FL may have various drawbacks or limits. In one example, since the centralized server is the sole aggregator for the participating nodes, the centralized server may serve as a single point of failure for the FL system. As a result, if the centralized server ceases to operate at any time, a bottleneck could arise in the entire FL process. In another example, since a participant sends its local model updates to the centralized server, significant communication overhead may arise in applications where numerous updates are applied. In further examples, statistical challenges in model training may arise due to the heterogeneity of computational resources existing for different participants, the heterogeneity of training data available to participants, and the heterogeneity of training tasks and associated models configured for different participants. In another example, even though raw data is not directly communicated between nodes in FL, security and privacy concerns may still arise from the exchange of ML model parameters (e.g. due to leakage of information about underlying data samples).

To address these limits associated with conventional FL architectures, a clustered or hierarchical approach to FL may be applied in which learning nodes working towards a common learning task are grouped together into clusters. In one example, UEs may group together to form clusters and designate cluster leaders (e.g., other UEs). The designated cluster leader for a cluster, rather than the FL parameter server directly, coordinates the learning task including local ML model training and updates within that cluster. This coordination is referred to as intra-cluster FL. After clusters are formed, the centralized FL parameter server may coordinate the learning task including global ML model training and updates among clusters. This coordination is referred to as inter-cluster FL. The cluster leaders may thus act as intermediaries between the learning nodes and the FL parameter server for coordinating neural network training and optimization between different clusters. As a result, neural network training may be achieved in a distributed manner using clustered FL with minimal bottlenecks, minimal communication overhead, minimal challenges to model training due to heterogeneity of computational resources, training data, training tasks, or associated ML models, and minimal security and privacy challenges that may arise in conventional FL.

The aforementioned limitations present in conventional FL may also be minimized using a peer-to-peer FL architecture. In the peer-to-peer approach, collaborative ML model training between participating nodes may be provided without a designated and centralized server for coordinating the training. Rather, participating nodes directly communicate with other participating nodes to coordinate and schedule neural network training, individual model updates, and aggregation of the individually updated models. As a result, neural network training may similarly be achieved in a distributed manner using peer-to-peer FL with minimal bottlenecks, minimal communication overhead, minimal challenges to model training due to heterogeneity of computational resources, training data, training tasks, or associated ML models, and minimal security and privacy challenges that may arise in conventional FL.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

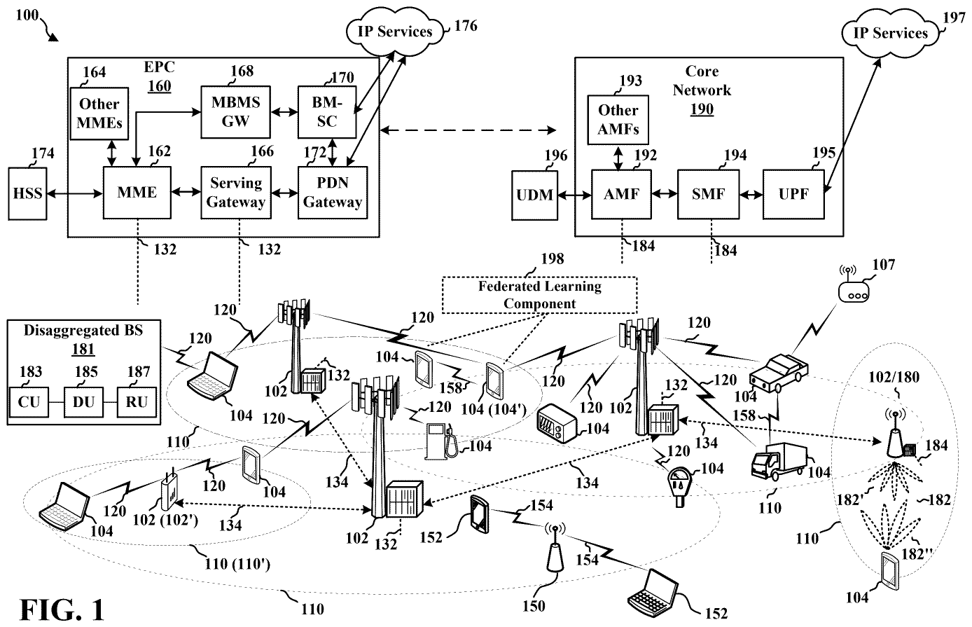

FIG. 1 is a diagram illustrating an example of a wireless communications system and an access network 100. The wireless communications system (also referred to as a wireless wide area network (WWAN)) includes base stations (BS) 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR 1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although beamformed signals are illustrated between UE 104 and base station 102/180, aspects of beamforming may similarly may be applied by UE 104 or RSU 107 to communicate with another UE 104 or RSU 107, such as based on V2X, V2V, or D2D communication.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

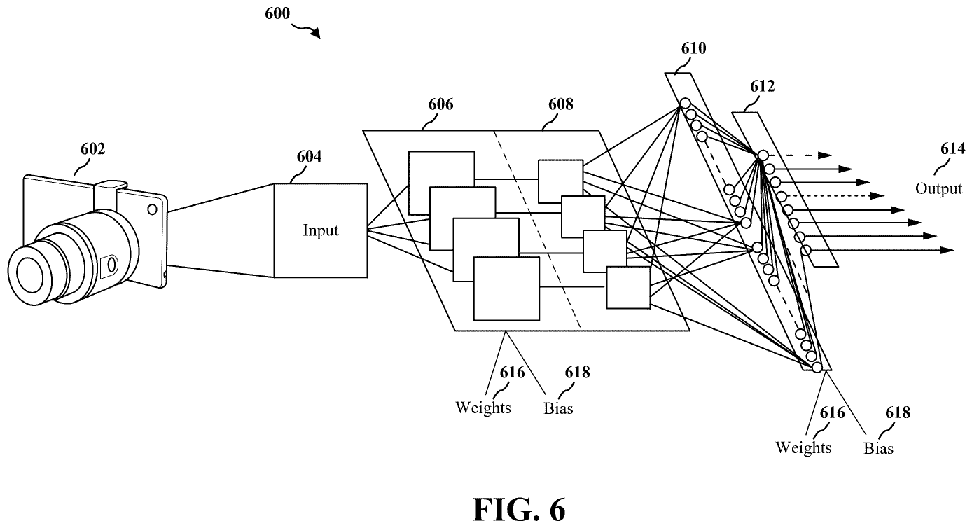

Some wireless communication networks may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), and/or a combination thereof and/or with other devices, which can be collectively referred to as vehicle-to-anything (V2X) communications. Referring again to FIG. 1, in certain aspects, a UE 104, e.g., a transmitting Vehicle User Equipment (VUE) or other UE, may be configured to transmit messages directly to another UE 104. The communication may be based on V2V/V2X/V2I or other D2D communication, such as Proximity Services (ProSe), etc. Communication based on V2V, V2X, V2I, and/or D2D may also be transmitted and received by other transmitting and receiving devices, such as Road Side Unit (RSU) 107, etc. Aspects of the communication may be based on PC5 or sidelink communication, e.g., as described in connection with the example in FIG. 3.

Referring again to FIG. 1, the UE 104 may include a federated learning component 198. The federated learning component 198 is configured to provide a first message including first FL information of the UE to a network node (e.g., another UE 104); obtain a second message including second FL information of the network node; and provide a ML model information update to the network node based on the first FL information and the second FL information. The UE 104 including federated learning component 198 may a transmitting device in sidelink communication such as a VUE, an IoT device, or other UE, or a receiving device in sidelink communication such as another VUE, another IoT device, or other UE.

The concepts and various aspects described herein may be applicable to vehicle-to-everything (V2X) or other similar areas, such as D2D communication, IoT communication, Industrial IoT (IIoT) communication, and/or other standards/protocols for communication in wireless/access networks. Additionally or alternatively, the concepts and various aspects described herein may be applicable to vehicle-to-pedestrian (V2P) communication, pedestrian-to-vehicle (P2V) communication, vehicle-to-infrastructure (V2I) communication, and/or other frameworks/models for communication in wireless/access networks. Additionally, the concepts and various aspects described herein may be applicable to NR or other similar areas, such as LTE, LTE-Advanced (LTE-A), Code Division Multiple Access (CDMA), Global System for Mobile communications (GSM), or other wireless/radio access technologies. Additionally, the concepts and various aspects described herein may be applicable for use in aggregated or disaggregated base station architectures, such as Open-Radio Access Network (O-RAN) architectures.

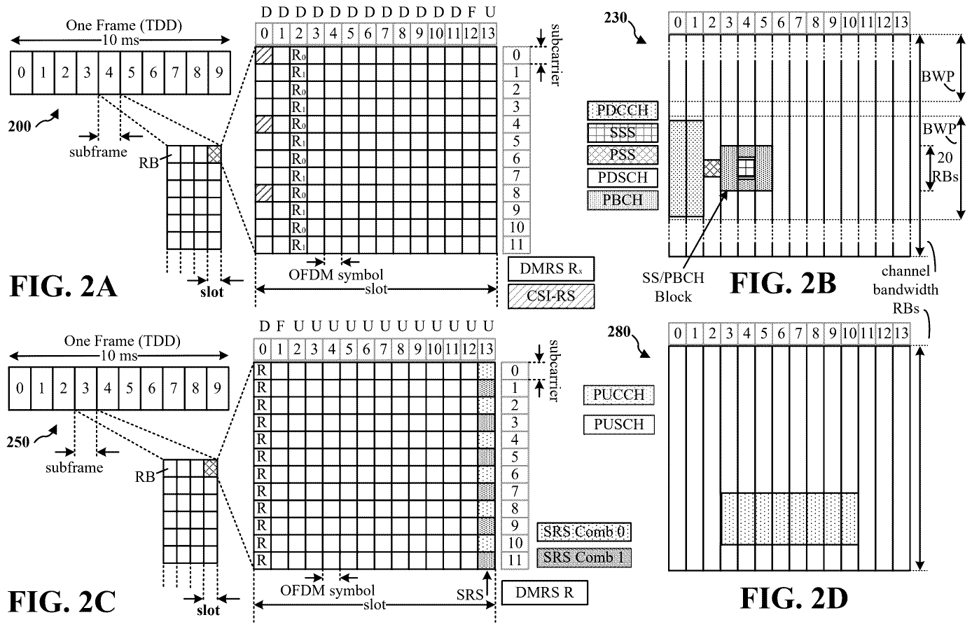

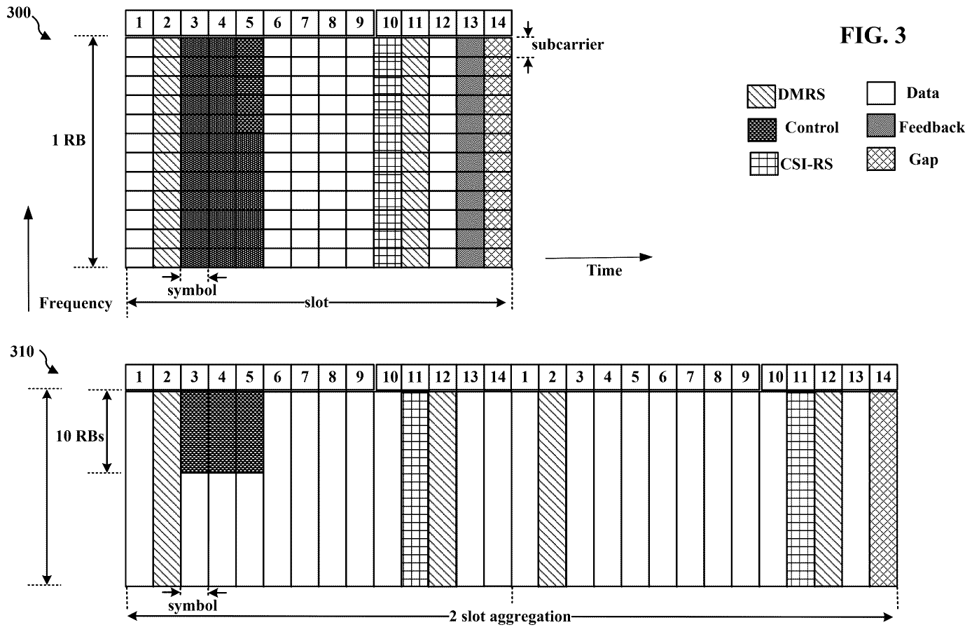

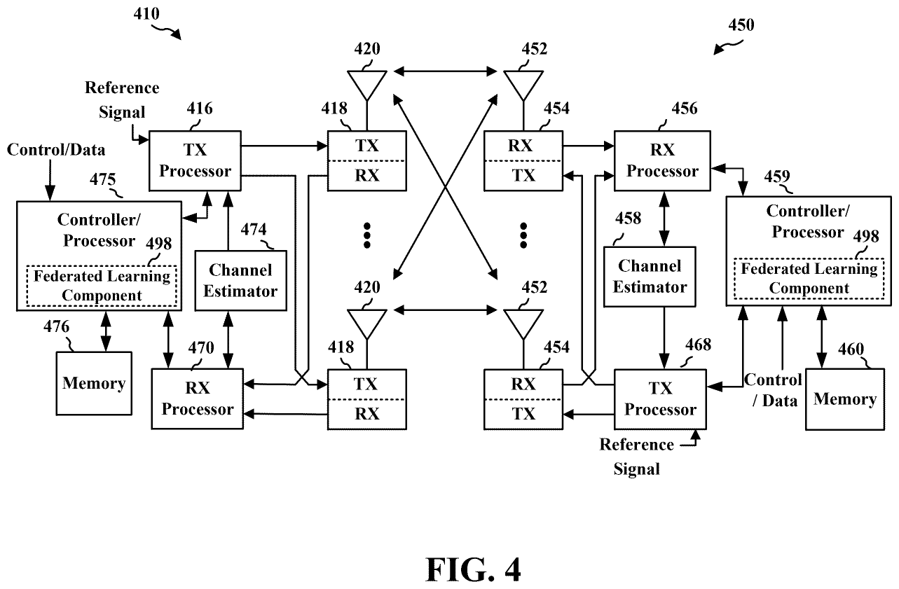

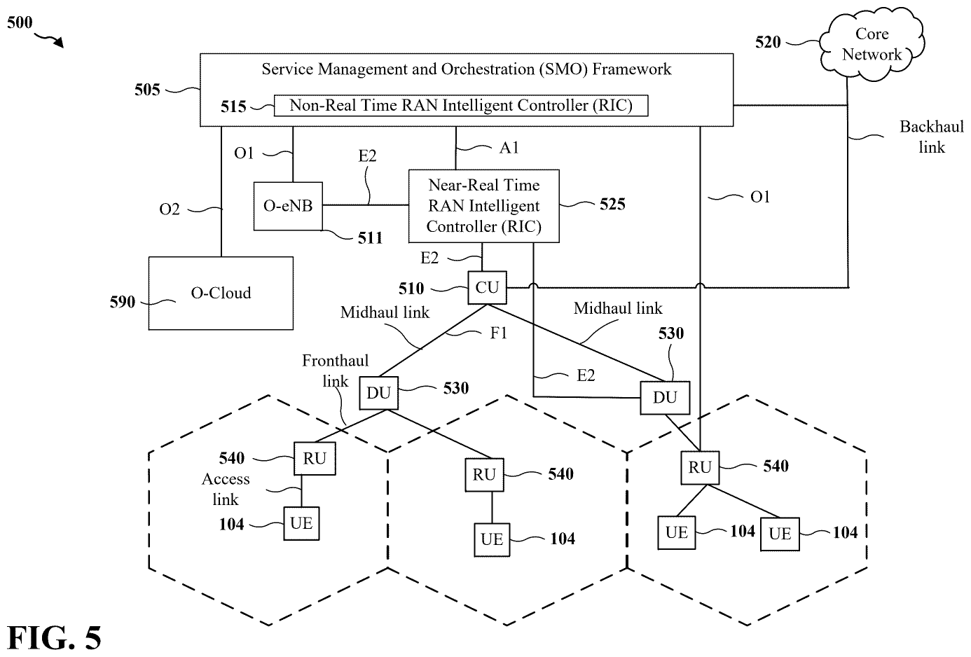

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34,28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

FIG. 3 illustrates example diagrams 300 and 310 illustrating example slot structures that may be used for wireless communication between UE 104 and UE 104′, e.g., for sidelink communication. The slot structure may be within a 5G/NR frame structure. Although the following description may be focused on 5G NR, the concepts described herein may be applicable to other similar areas, such as LTE, LTE-A, CDMA, GSM, and other wireless technologies. This is merely one example, and other wireless communication technologies may have a different frame structure and/or different channels. A frame (10 ms) may be divided into 10 equally sized subframes (1 ms). Each subframe may include one or more time slots. Subframes may also include mini-slots, which may include, for example, 7, 4, or 2 symbols. Each slot may include 7 or 14 symbols, depending on the slot configuration. For slot configuration 0, each slot may include 14 symbols, and for slot configuration 1, each slot may include 7 symbols. Diagram 300 illustrates a single slot transmission, e.g., which may correspond to a 0.5 ms transmission time interval (TTI). Diagram 310 illustrates an example two-slot aggregation, e.g., an aggregation of two 0.5 ms TTIs. Diagram 300 illustrates a single RB, whereas diagram 310 illustrates N RBs. In diagram 310, 10 RBs being used for control is merely one example. The number of RBs may differ.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 3, some of the REs may comprise control information, e.g., along with demodulation RS (DMRS). FIG. 3 also illustrates that symbol(s) may comprise CSI-RS. The symbols in FIG. 3 that are indicated for DMRS or CSI-RS indicate that the symbol comprises DMRS or CSI-RS REs. Such symbols may also comprise REs that include data. For example, if a number of ports for DMRS or CSI-RS is 1 and a comb-2 pattern is used for DMRS/CSI-RS, then half of the REs may comprise the RS and the other half of the REs may comprise data. A CSI-RS resource may start at any symbol of a slot, and may occupy 1, 2, or 4 symbols depending on a configured number of ports. CSI-RS can be periodic, semi-persistent, or aperiodic (e.g., based on DCI triggering). For time/frequency tracking, CSI-RS may be either periodic or aperiodic. CSI-RS may be transmitted in busts of two or four symbols that are spread across one or two slots. The control information may comprise Sidelink Control Information (SCI). At least one symbol may be used for feedback, as described herein. A symbol prior to and/or after the feedback may be used for turnaround between reception of data and transmission of the feedback. Although symbol 12 is illustrated for data, it may instead be a gap symbol to enable turnaround for feedback in symbol 13. Another symbol, e.g., at the end of the slot may be used as a gap. The gap enables a device to switch from operating as a transmitting device to prepare to operate as a receiving device, e.g., in the following slot. Data may be transmitted in the remaining REs, as illustrated. The data may comprise the data message described herein. The position of any of the SCI, feedback, and LBT symbols may be different than the example illustrated in FIG. 3. Multiple slots may be aggregated together. FIG. 3 also illustrates an example aggregation of two slot. The aggregated number of slots may also be larger than two. When slots are aggregated, the symbols used for feedback and/or a gap symbol may be different that for a single slot. While feedback is not illustrated for the aggregated example, symbol(s) in a multiple slot aggregation may also be allocated for feedback, as illustrated in the one slot example.

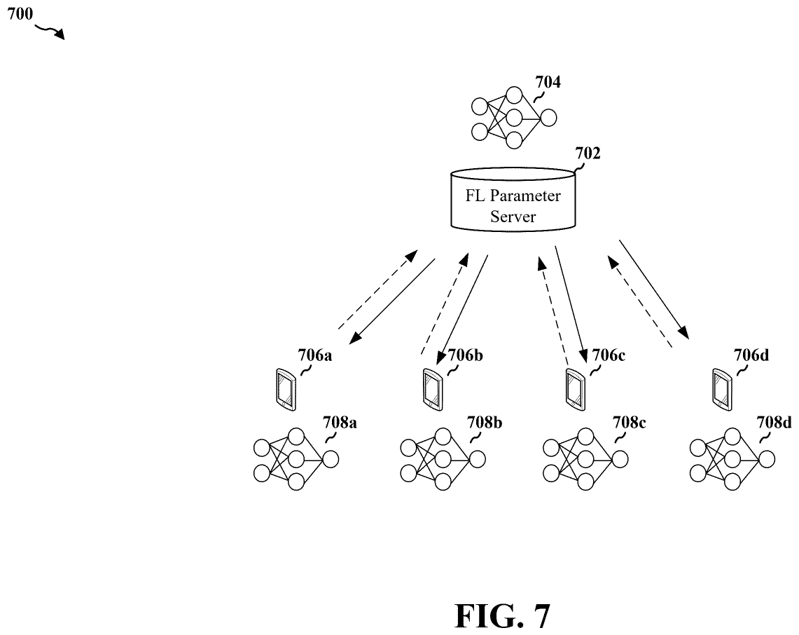

FIG. 4 is a block diagram of a first wireless communication device 410 in communication with a second wireless communication device 450, e.g., via V2V/V2X/D2D communication or in an access network. The device 410 may comprise a transmitting device communicating with a receiving device, e.g., device 450, via V2V/V2X/D2D communication. The communication may be based, e.g., on sidelink. The transmitting device 410 may comprise a UE, a base station, an RSU, etc. The receiving device may comprise a UE, a base station, an RSU, etc.

IP packets from the EPC 160 may be provided to a controller/processor 475. The controller/processor 475 implements layer 3 and layer 2 functionality. Layer 3includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 416 and the receive (RX) processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the device 450. Each spatial stream may then be provided to a different antenna 420 via a separate transmitter 418TX. Each transmitter 418TX may modulate an RF carrier with a respective spatial stream for transmission.

At the device 450, each receiver 454RX receives a signal through its respective antenna 452. Each receiver 454RX recovers information modulated onto an RF carrier and provides the information to the receive (RX) processor 456. The TX processor 468 and the RX processor 456 implement layer 1 functionality associated with various signal processing functions. The RX processor 456 may perform spatial processing on the information to recover any spatial streams destined for the device 450. If multiple spatial streams are destined for the device 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the device 410. These soft decisions may be based on channel estimates computed by the channel estimator 458. The soft decisions are then decoded and deinterleaved to recover the data and control signals that were originally transmitted by the device 410 on the physical channel. The data and control signals are then provided to the controller/processor 459, which implements layer 3 and layer 2 functionality.

The controller/processor 459 can be associated with a memory 460 that stores program codes and data. The memory 460 may be referred to as a computer-readable medium. The controller/processor 459 provides demultiplexing between transport and logical channels, packet reassembly, deciphering, header decompression, and control signal processing to recover IP packets from the EPC 160. The controller/processor 459 is also responsible for error detection using an ACK and/or NACK protocol to support HARQ operations.

Similar to the functionality described in connection with the DL transmission by the device 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 458 from a reference signal or feedback transmitted by device 410 may be used by the TX processor 468 to select the appropriate coding and modulation schemes, and to facilitate spatial processing. The spatial streams generated by the TX processor 468 may be provided to different antenna 452 via separate transmitters 454TX. Each transmitter 454TX may modulate an RF carrier with a respective spatial stream for transmission.

The transmission is processed at the device 410 in a manner similar to that described in connection with the receiver function at the device 450. Each receiver 418RX receives a signal through its respective antenna 420. Each receiver 418RX recovers information modulated onto an RF carrier and provides the information to a RX processor 470.

The controller/processor 475 can be associated with a memory 476 that stores program codes and data. The memory 476 may be referred to as a computer-readable medium. The controller/processor 475 provides demultiplexing between transport and logical channels, packet reassembly, deciphering, header decompression, control signal processing to recover IP packets from the device 450. IP packets from the controller/processor 475 may be provided to the EPC 160. The controller/processor 475 is also responsible for error detection using an ACK and/or NACK protocol to support HARQ operations.

At least one of the TX processor 416, 468, the RX processor 456, 470, and the controller/processor 459, 475 may be configured to perform aspects in connection with federated learning component 198 of FIG. 1. For example, the controller/processor 459, 475 may include a federated learning component 498 which is configured to provide a first message including first FL information of the UE to a network node (e.g., device 410, 450); obtain a second message including second FL information of the network node; and provide a ML model information update to the network node based on the first FL information and the second FL information.

In one example, the federated learning component 498 of controller/processor 475 in device 410 may provide the first message to device 450 via TX processor 416, which may transmit the first message via antennas 420 to device 450. The federated learning component 498 of controller/processor 475 in device 410 may obtain the second message from device 450 via RX processor 470, which may receive the second message from device 450 via antennas 420. The federated learning component 498 of controller/processor 475 in device 410 may provide the ML model information update to device 450 via TX processor 416, which may transmit the first message via antennas 420 to device 450.

In another example, the federated learning component 498 of controller/processor 459 in device 450 may provide the first message to device 410 via TX processor 468, which may transmit the first message via antennas 452 to device 410. The federated learning component 498 of controller/processor 459 in device 450 may obtain the second message from device 410 via RX processor 456, which may receive the second message from device 410 via antennas 452. The federated learning component 498 of controller/processor 459 in device 450 may provide the ML model information update to device 410 via TX processor 468, which may transmit the first message via antennas 452 to device 410.

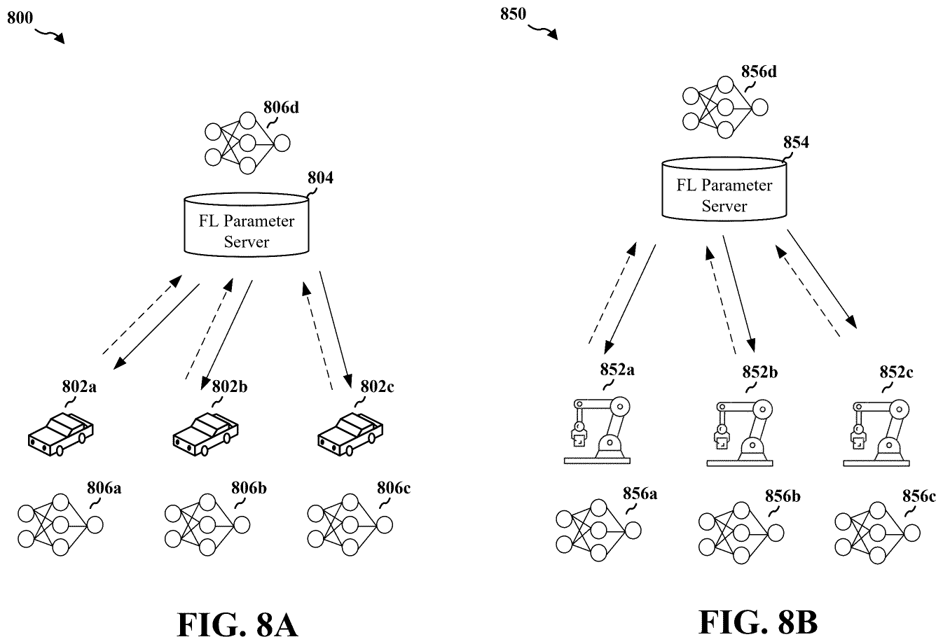

FIG. 5 shows a diagram illustrating an example disaggregated base station 500 architecture. The disaggregated base station 500 architecture may include one or more CUs 510 (e.g., CU 183 of FIG. 1) that can communicate directly with a core network 520 via a backhaul link, or indirectly with the core network 520 through one or more disaggregated base station units (such as a Near-Real Time RIC 525 via an E2 link, or a Non-Real Time RIC 515 associated with a Service Management and Orchestration (SMO) Framework 505, or both). A CU 510 may communicate with one or more DUs 530 (e.g., DU 185 of FIG. 1) via respective midhaul links, such as an F1 interface. The DUs 530 may communicate with one or more RUs 540 (e.g., RU 187 of FIG. 1) via respective fronthaul links. The RUs 540 may communicate respectively with UEs 104 via one or more radio frequency (RF) access links. In some implementations, the UE 104 may be simultaneously served by multiple RUs 540.

Each of the units, i.e., the CUs 510, the DUs 530, the RUs 540, as well as the Near-RT RICs 525, the Non-RT RICs 515 and the SMO Framework 505, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 510 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 510. The CU 510 may be configured to handle user plane functionality (i.e., Central Unit-User Plane (CU-UP)), control plane functionality (i.e., Central Unit-Control Plane (CU-CP)), or a combination thereof. In some implementations, the CU 510 can be logically split into one or more CU-UP units and one or more CU-CP units. The CU-UP unit can communicate bidirectionally with the CU-CP unit via an interface, such as the E1 interface when implemented in an O-RAN configuration. The CU 510 can be implemented to communicate with the DU 530, as necessary, for network control and signaling.

The DU 530 may correspond to a logical unit that includes one or more base station functions to control the operation of one or more RUs 540. In some aspects, the DU 530 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 530 may further host one or more low PHY layers. Each layer (or module) can be implemented with an interface configured to communicate signals with other layers (and modules) hosted by the DU 530, or with the control functions hosted by the CU 510.

Lower-layer functionality can be implemented by one or more RUs 540. In some deployments, an RU 540, controlled by a DU 530, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 540 can be implemented to handle over the air (OTA) communication with one or more UEs 120. In some implementations, real-time and non-real-time aspects of control and user plane communication with the RU(s) 540 can be controlled by the corresponding DU 530. In some scenarios, this configuration can enable the DU(s) 530 and the CU 510 to be implemented in a cloud-based RAN architecture, such as a vRAN architecture.

The SMO Framework 505 may be configured to support RAN deployment and provisioning of non-virtualized and virtualized network elements. For non-virtualized network elements, the SMO Framework 505 may be configured to support the deployment of dedicated physical resources for RAN coverage requirements, which may be managed via an operations and maintenance interface (such as an O1 interface). For virtualized network elements, the SMO Framework 505 may be configured to interact with a cloud computing platform (such as an open cloud (O-Cloud) 590) to perform network element life cycle management (such as to instantiate virtualized network elements) via a cloud computing platform interface (such as an O2 interface). Such virtualized network elements can include, but are not limited to, CUs 510, DUs 530, RUs 540 and Near-RT RICs 525. In some implementations, the SMO Framework 505 can communicate with a hardware aspect of a 4G RAN, such as an open eNB (O-eNB) 511, via an O1 interface. Additionally, in some implementations, the SMO Framework 505 can communicate directly with one or more RUs 540 via an O1 interface. The SMO Framework 505 also may include the Non-RT RIC 515 configured to support functionality of the SMO Framework 505.

The Non-RT RIC 515 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 525. The Non-RT RIC 515 may be coupled to or communicate with (such as via an A1 interface) the Near-RT RIC 525. The Near-RT RIC 525 may be configured to include a logical function that enables near-real-time control and optimization of RAN elements and resources via data collection and actions over an interface (such as via an E2 interface) connecting one or more CUs 510, one or more DUs 530, or both, as well as an O-eNB, with the Near-RT RIC 525.

In some implementations, to generate AI/ML models to be deployed in the Near-RT RIC 525, the Non-RT RIC 515 may receive parameters or external enrichment information from external servers. Such information may be utilized by the Near-RT RIC 525 and may be received at the SMO Framework 505 or the Non-RT RIC 515 from non-network data sources or from network functions. In some examples, the Non-RT RIC 515 or the Near-RT RIC 525 may be configured to tune RAN behavior or performance. For example, the Non-RT RIC 515 may monitor long-term trends and patterns for performance and employ AI/ML models to perform corrective actions through the SMO Framework 505 (such as reconfiguration via O1) or via creation of RAN management policies (such as A1 policies).

UEs 104 including at least the controller/processor 459, 475 of device 410, 450, base stations 102/180 including aggregated and disaggregated base stations 181, or other network nodes, may be configured to perform AI/ML tasks using artificial neural networks (ANNs). ANNs, or simply neural networks, are computational learning systems that use a network of functions to translate a data input of one form into a desired output, usually in another form. Examples of ANNs include multilayer perceptrons (MLPs), convolutional neural networks (CNNs), deep neural networks (DNNs), deep convolutional networks (DCNs), and recurrent neural networks (RNNs), as well as other neural networks. Generally, ANNs include layered architectures in which the output of one layer of neurons is input to a second layer of neurons (via connections or synapses), the output of the second layer of neurons becomes an input to a third layer of neurons, and so forth. These neural networks may be trained to recognize a hierarchy of features and thus have increasingly been used in object recognition applications. For instance, neural networks may employ supervised learning tasks such as classification which incorporates a ML model such as logistic regression, support vector machines, boosting, or other classifiers to perform object detection and provide bounding boxes of a class or category in an image. Moreover, these multi-layered architectures may be fine-tuned using backpropagation or gradient descent to result in more accurate predictions.

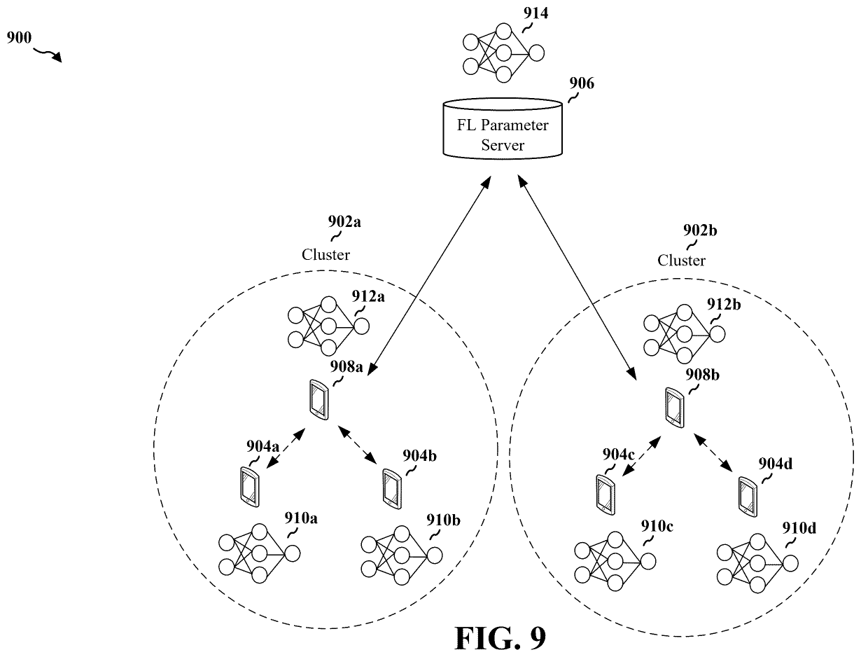

FIG. 6 illustrates an example of a neural network 600, specifically a CNN. The CNN may be designed to detect objects sensed from a camera 602, such as a vehicle-mounted camera, or other sensor. The neural network 600 may initially receive an input 604, for instance an image such as a speed limit sign having a size of 32×32 pixels (or other object or size). During a forward pass, the input image is initially passed through a convolutional layer 606 including multiple convolutional kernels (e.g., six kernels of size 5×5 pixels, or some other quantity or size) which slide over the image to detect basic patterns or features such as straight edges and corners. The images output from the convolutional layer 606 (e.g., six images of size 28×28 pixels, or some other quantity or size) are passed through an activation function such as a rectified linear unit (ReLU), and then as inputs into a subsampling layer 608 which scales down the size of the images for example by a factor of two (e.g., resulting in six images of size 14×14 pixels, or some other quantity or size). These downscaled images output from the subsampling layer 608 may similarly be passed through an activation function (e.g., ReLU or other function), and similarly as inputs through subsequent convolutional layers, subsampling layers, and activation functions (not shown) to detect more complex features and further scale down the image or kernel sizes. These outputs are eventually passed as inputs into a fully connected layer 610 in which each of the nodes output from the prior layer are connected to all of the neurons in the current layer. The output from this layer may similarly be passed through an activation function and potentially as inputs through one or more other fully connected layers (not shown). Afterwards, the outputs are passed as inputs into an output layer 612 which transforms the inputs into an output 614 such as a probability distribution (e.g., using a softmax function). The probability distribution may include a vector of confidence levels or probability estimates that the inputted image depicts a predicted feature, such as a sign or speed limit value (or other object).

During training, an ML model (e.g., a classifier) is initially created with weights 616 and bias(es) 618 respectively for different layers of neural network 600. For example, when inputs from a training image (or other source) enter a given layer of a MLP or CNN, a function of the inputs and weights, summed with the bias(es), may be transformed using an activation function before being passed to the next layer. The probability estimate resulting from the final output layer may then be applied in a loss function which measures the accuracy of the ANN, such as a cross-entropy loss function. Initially, the output of the loss function may be significantly large, indicating that the predicted values are far from the true or actual values. To reduce the value of the loss function and result in more accurate predictions, gradient descent may be applied.

In gradient descent, a gradient of the loss function may be calculated with respect to each weight of the ANN using backpropagation, with gradients being calculated for the last layer back through to the first layer of the neural network 600. Each weight may then be updated using the gradients to reduce the loss function with respect to that weight until a global minimization of the loss function is obtained, for example using stochastic gradient descent. For instance, after each weight adjustment, a subsequent iteration of the aforementioned training process may occur with the same or new training images, and if the loss function is still large (even though reduced), backpropagation may again be applied to identify the gradient of the loss function with respect to each weight. The weights may again be updated, and the process may continue to repeat until the differences between predicted values and actual values are minimized.

Network nodes such as UEs or base stations may train neural networks (e.g., neural network 600) using federated learning (FL). In contrast to centralized machine learning techniques where local data sets are typically all uploaded to one server, FL allows for high quality ML models to be generated without the need for aggregating the distributed data. As a result, FL is convenient for parallel processing, significantly reduces costs associated with message exchanges, and preserves data privacy.

In a FL framework, nodes such as UEs may learn a global ML model via the passing of messages between the nodes through the central coordinator. For instance, the nodes may provide weights, biases, gradients, or other ML information to each other (other nodes) through messages exchanged between nodes via the central coordinator (e.g., a base station, RSU, an edge server, etc.).

Each node in a FL environment utilizes a dataset to locally train and update a coordinated global, ML model. The dataset may be a local data set that a node or device may obtain for a certain ML task (e.g., object detection, etc.). The data in a given dataset may be preloaded or may be accumulated throughout a device lifetime. For example, an accumulated dataset may include recorded data that a node observes and locally stores at the device from an on-board sensor such as a camera.

The global ML model may be defined by its model architecture and model weights. An example of a model architecture is a neural network, such as the CNN described with respect to FIG. 6, which may include multiple hidden layers, multiple neurons per layer, and synapses connecting these neurons together. The model weights are applied to data passing through the individual layers of the ML model for processing by the individual neurons.

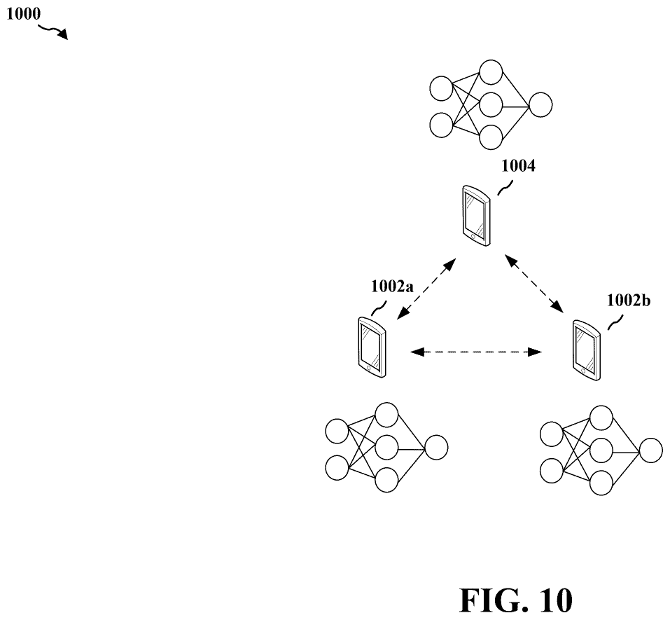

FIG. 7 illustrates an example 700 of a FL architecture. An FL parameter server 702 initializes a global ML model 704 (W₀^{G}) (e.g., a classifier in a pre-configured ML architecture such as the CNN of FIG. 6 with random or default ML weights) and broadcasts the global ML model 704 to participating devices or learning nodes 706 (e.g., UEs). Upon receipt of the global ML model at the learning nodes, an iterative process of FL may begin. For instance, upon receiving the global ML model 704 (Wₜ^{G}) at a given iteration t, the learning nodes 706 (k nodes 706 a, 706 b, 706 c, 706 d) locally train their respective model 708 (models 708a, 708b, 708c, 708d) using their local dataset, which may be a preconfigured data set such as a training set and/or sensed data from the environment. After training, the learning nodes update their respective k-th model Wₜ^{k} (e.g., the local weights) until a minimization or optimization of a k-th loss function or cost function Fₖ (Wₜ^{k}) for that model is achieved. At this point, the learning nodes may have different local models Wₜ^{k} due to having different updated weights.

Afterwards, the learning nodes 706 transmit information corresponding to their local updated models Wₜ^{k} to the FL parameter server 702. To reduce transmission traffic, the corresponding information may be, for example, the modified weights, weights that changed more than a threshold, or the multiplicative or additive delta amounts or percentages for those weights. Upon receipt of this corresponding information, the FL parameter server aggregates the respective weights of the respective models 708 (e.g., by averaging the weights or performing some other calculation on the weights). The FL parameter server 702 may thus generate an updated global model Wₜ₊₁^{G} including the aggregated weights, after which the aforementioned process may repeat for subsequent iteration t+1. For instance, the FL parameter server 702 may broadcast the updated global model Wₜ₊₁^{G} to the learning nodes 706 to again perform training and local updates based on the same dataset or a different local dataset. To reduce transmission traffic, broadcasting the update may comprise transmitting the modified weights, weights that changed more than a threshold, or the multiplicative or additive delta amounts or percentages for those weights. After the nodes receive the broadcasted update and perform the training and local updates, the nodes may again share their respectively updated models to the FL parameter server for subsequent aggregation and global model update. This process may continue to repeat in further iterations and result in further updates to the global model Wₜ^{G} until a minimization of a loss function F_{G} (Wₜ^{G}) for the global model is obtained, or until a predetermined number of iterations has been reached.

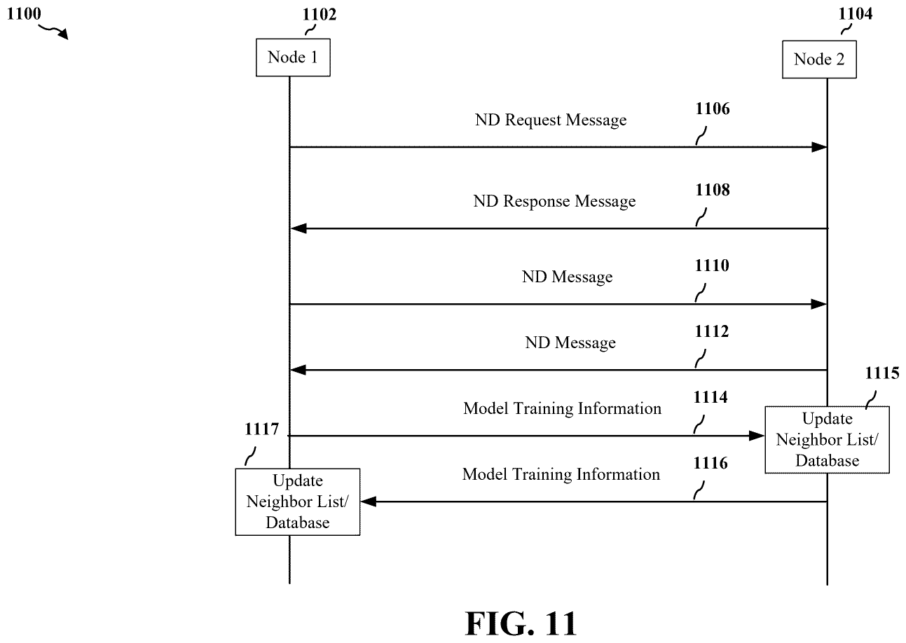

FIGS. 8A and 8B illustrate examples 800, 850 of different applications associated with wireless connected devices that may benefit from FL, including connected vehicles for autonomous driving (FIG. 8A) and mobile robots for manufacturing (FIG. 8B). For instance, in the example 800 of FIG. 8A, network nodes 802 (nodes 802a, 802b, 802c, e.g., VUEs such as learning nodes 706 in FIG. 7) equipped with vision sensors such as cameras, light detection and ranging (LIDAR), or radio detection and ranging (RADAR), may communicate with a FL parameter server 804 (e.g., a base station or an RSU) to collaboratively train and enhance the accuracy of a neural network 806 (neural network 806a, 806b, 806c, 806d) for detecting objects and object bounding boxes (OBBs) in connection with autonomous driving. Similarly, in the example 850 of FIG. 8B, network nodes 852 (nodes 852a, 852 b, 852c, e.g., mobile robot UEs such as learning nodes 706 in FIG. 7) equipped with inertial measurement units (IMUs), RADAR, camera, or other sensors in a manufacturing environment may communicate with a FL parameter server 854 (e.g., a base station) in mmWave frequencies to collaboratively train a neural network 856 (neural network 856a, 856b, 856c, 856d) associated with a manufacturing-related task.

However, conventional FL architectures rely on a centralized server (e.g., FL parameter server 702, 804, 854) to create, aggregate, and refine a global ML model for participating nodes, thus necessitating the transmission of locally trained ML model information from participating nodes to the server during an FL iteration. To reduce transmission traffic, this information may include for example, modified weights, weights that changed more than a threshold, or multiplicative or additive delta amounts or percentages for those weights, This centralized approach to FL may have various drawbacks or limits. For instance, the centralized server may serve as a single point of failure for the FL system, significant communication overhead may arise in applications involving numerous model updates, or statistical challenges in model training or security or privacy concerns may arise.

To address these limits associated with conventional FL architectures, a clustered or hierarchical approach to FL may be applied in which learning nodes working towards a common learning task are grouped together into clusters. In clustered FL, multiple clusters may be formed from respective groups of learning nodes (e.g., UEs) having a local dataset and sharing a common ML task such as object detection or classification (e.g., detecting an OBB, a vehicle or pedestrian on a road, etc.). In one example, UEs may group together to form clusters and designate cluster leaders (e.g., other UEs) without network assistance (e.g., without involvement of a base station or RSU), although in other examples, the cluster formation and leader identification may be configured with network assistance (e.g., via messages circulated within the network identifying clusters and confirming cluster leaders). For instance, a participating node in a cluster may be elected or designated as a leader by other participating nodes in the cluster, without network involvement. Cluster leaders may themselves also be learning nodes within a respective cluster.

Moreover, in contrast to conventional FL, in hierarchical FL the designated cluster leader for each cluster, rather than the FL parameter server directly, coordinates the learning task including local ML model training and updates within that cluster. This coordination is referred to as intra-cluster FL. For instance, individual nodes within a cluster may pass messages including local updates to ML model weights to a cluster leader (e.g., a UE designated with an identifier as the leader of that cluster) to aggregate and send the updated local model back to the individual nodes within that cluster. After clusters are formed, the centralized FL parameter server (e.g., an edge server, RSU, or base station) may coordinate the learning task including global ML model training and updates between clusters. This coordination is referred to as inter-cluster FL. For instance, individual cluster leaders of respective clusters may pass messages including aggregated local updates to ML model weights to the FL parameter server to aggregate and send the updated global ML model back to the individual cluster leaders, which in turn, will pass the updated global model to their respective cluster members to further train and update. The cluster leaders may thus act as intermediaries between the learning nodes and the FL parameter server for coordinating neural network training and optimization between different clusters.

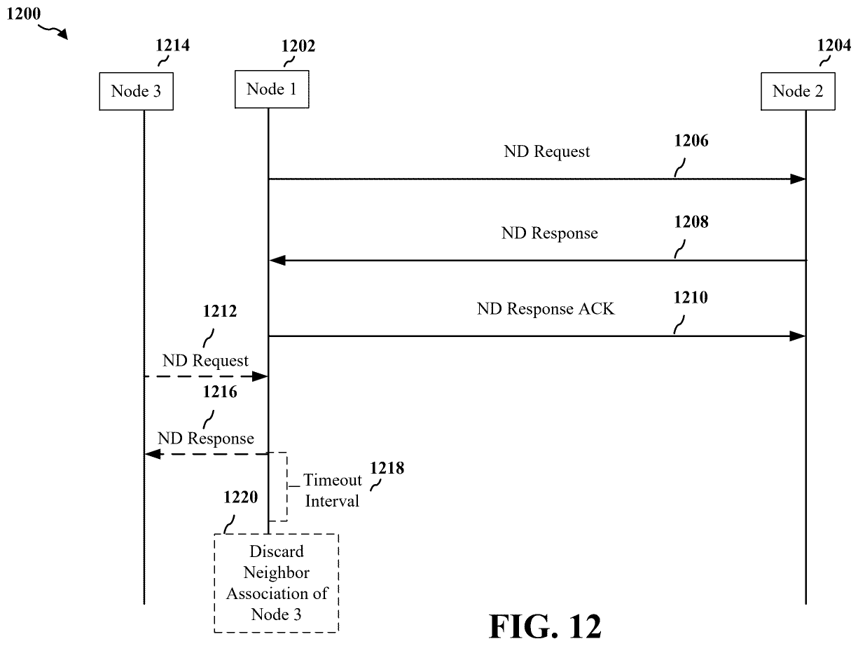

FIG. 9 illustrates an example 900 of a clustered FL architecture including clusters 902 (clusters 902a, 902b) of UEs 904 (UEs 904a, 904b, 904c, 904d, e.g., vehicle UEs, pedestrian UEs, etc.) in communication with an FL parameter server 906 (e.g., a base station, a RSU, an edge server, or other network entity). UEs 904 sharing common learning tasks, models, datasets, or computational resources may be grouped into one or more clusters, and multiple clusters 902 of such UEs may be formed. A cluster leader 908 (cluster leader 908a, 908b) may be designated for a cluster, with or without network assistance. For example, without network assistance, UEs 904 may elect or subscribe to one of the UEs as cluster leader 908 for a given cluster. In an alternative example, with network assistance, the FL parameter server 906 (e.g., a base station) may designate an RSU, edge server, or other network entity as cluster leader 908 for a given cluster if that network entity is in communication with UEs 904 of that respective cluster, as well as designate the UEs 904 participating in respective clusters.

UEs 904 in a given cluster may conduct a similar training process to that of the conventional FL process described with respect to FIG. 7, except that the cluster leader 908 serve as an aggregator for its respective clusters rather than the FL parameter server, and model training occurs at multiple levels (intra-cluster and inter-cluster). In one example, the cluster leaders 908 may serve as aggregators for their respective clusters 902 without themselves participating in model training. For instance, the cluster leader 908 of a given cluster may groupcast an initialized ML model to the UEs 904 within the cluster 902 to perform local training, which UEs in turn send their individually updated ML models 910 (models 910a, 910b, 910c, 910d respectively for different UEs) back to the cluster leader 908 to aggregate into an updated local model 912 for that cluster. The cluster leader 908 may then groupcast the updated local model 912 (model 912a, 912b respectively for different cluster leaders) to the UEs 904 to again perform local training in a next iteration and this intra-cluster process may repeat in further iterations. Additionally, at certain times or in response to certain events, the cluster leaders 908 may communicate their respective, updated local models to the FL parameter server 906 to aggregate into an updated global model 914 for the clusters. The FL parameter server 906 may then send these aggregated global models back to the cluster leaders 908 to be circulated within their respective clusters 902. In another example, the cluster leaders 908 may themselves participate in model training in addition to serving as aggregators for their respective clusters 902. In such case, the cluster leaders 908 may perform the aforementioned functions of aggregator in addition to performing local training and updates similar to UEs 904. Thus, unlike conventional FL where learning nodes communicate directly with the FL parameter server for model optimization, here the cluster leaders communicate directly with the FL parameter server, and the learning nodes within a cluster instead communicate directly with the cluster leader. As a result, neural network training may be achieved in a distributed manner using clustered FL with minimal bottlenecks, minimal communication overhead, minimal challenges to model training due to heterogeneity of computational resources, training data, training tasks, or associated ML models, and minimal security and privacy challenges that may arise in conventional FL.

The aforementioned limitations present in conventional FL may also be minimized using a peer-to-peer FL architecture, rather than a clustered FL architecture such as illustrated in FIG. 9. In the peer-to-peer approach, collaborative ML model training between participating nodes may be provided without a designated and centralized server (e.g., without FL parameter server 906) for coordinating the training. Rather, participating nodes directly communicate with other participating nodes to coordinate and schedule neural network training, individual model updates, and aggregation of the individually updated models.

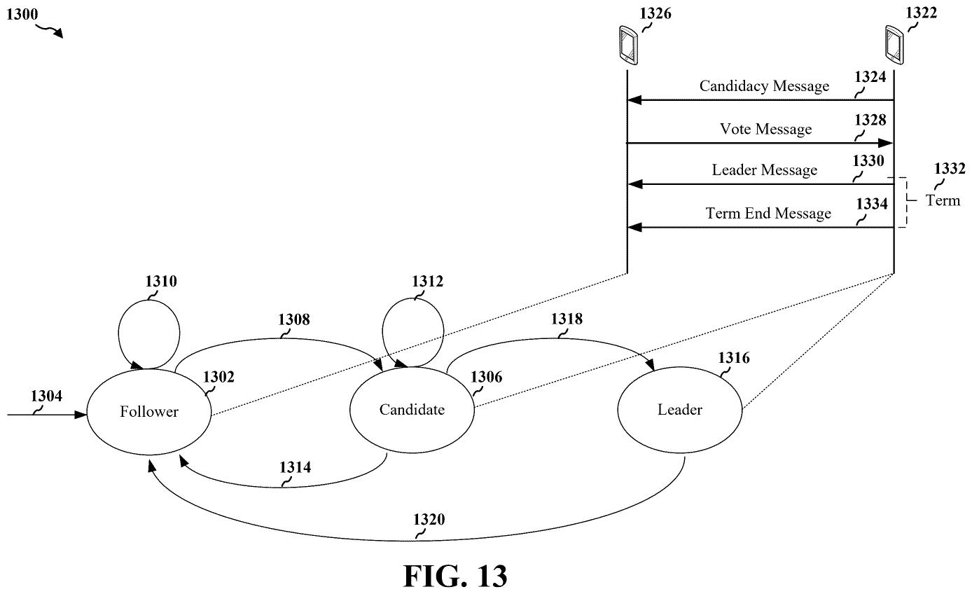

FIG. 10 illustrates an example 1000 of a peer-to-peer FL architecture including UEs 1002 (UEs 1002a, 1002b, e.g., vehicle UEs, pedestrian UEs, etc.) which directly communicate with other UEs for ML model training. In one example, the UEs 1002 may elect one of the UEs 1002 as a leader 1004 for a duration of time to coordinate ML model training among the UEs 1002. In one example, the leader 1004 may serve as aggregator without itself participating in model training. During training, the leader 1004 may receive and aggregate ML model updates from the UEs 1002, after which the leader may send the aggregated ML model updates back to the UEs 1002 for further training and update. This training process is similar to the intra-cluster approach described with respect to FIG. 9, except where the cluster leader in that example is here replaced by leader 1004. In another example, the leader 1004 may itself participate in model training in addition to serving as aggregators, in which case the leader 1004 may perform the aforementioned functions of aggregator in addition to performing model training and updates similar to UEs 1002. In an alternative example, none of the UEs may be leaders 1004, and the UEs 1002 may instead synchronously or asynchronously aggregate ML model updates of other UEs 1002. As a result, neural network training may similarly be achieved in a distributed manner using peer-to-peer FL with minimal bottlenecks, minimal communication overhead, minimal challenges to model training due to heterogeneity of computational resources, training data, training tasks, or associated ML models, and minimal security and privacy challenges that may arise in conventional FL.

Various examples of signaling procedures between network nodes (e.g., UEs) are provided in order to implement clustered FL. In one example, a neighbor discovery procedure is provided in which nodes (e.g., UEs) may discover other nodes (e.g., other UEs, or the FL parameter server) in proximity to or neighboring each other that may participate in a ML training task. In another example, upon completion of neighbor discovery, a signaling procedure for cluster formation and leader election is provided in which nodes participating in the ML training tasks may form clusters with other discovered nodes (without network involvement) and elect cluster leaders (ML model weight aggregators) for respective clusters further based on configured criteria. The signaling procedure for neighbor discovery and the signaling procedure for cluster formation and leader election may be distinct procedures carried out sequentially as previously described. Alternatively, neighbor discovery and cluster formation and leader election may be carried out simultaneously in a combined signaling procedure. In a further example, upon completion of cluster formation and leader election, a signaling procedure for clustered FL training may be provided in which nodes may perform intra-FL training coordinated by a cluster leader within a respective cluster through message passing between learning nodes and the cluster leader. In a further example, upon completion of cluster formation and leader election, a signaling procedure for clustered FL training may be provided in which nodes may perform inter-FL training coordinated by an FL parameter server across different clusters through message exchanges between respective cluster leaders and the FL parameter server. The foregoing examples of signaling procedures may apply sidelink communication (e.g., over a PC5 interface) between devices such as UEs, downlink/uplink communication (e.g., over a Uu interface) between UEs and a network entity such as a base station or RSU, or a combination of sidelink and downlink/uplink communication.

Various examples of signaling procedures between network nodes (e.g., UEs) are also provided in order to implement peer-to-peer FL. In one example, a neighbor discovery procedure is provided in which nodes (e.g., UEs) may discover other nodes (e.g., other UEs, or the FL parameter server) in proximity to or neighboring each other that may participate in a ML training task. In another example, upon completion of neighbor discovery, a signaling procedure for leader election in a peer-to-peer FL setting may be provided in which nodes participating in the ML training tasks may elect a leader for ML model weight aggregation among other discovered nodes based on configured criteria. In a further example, upon completion of leader election, a signaling procedure for peer-to-peer FL training may be provided in which the leader coordinates FL training among peer nodes. In another example where none of the peer nodes operate as leaders, a signaling procedure for peer-to-peer FL training may be provided in which peer nodes synchronously coordinate FL training among other peer nodes. In a further example where none of the peer nodes operate as leaders, a signaling procedure for peer-to-peer FL training may be provided in which peer nodes asynchronously coordinate FL training among other peer nodes. The foregoing examples of signaling procedures may apply sidelink communication (e.g., over a PC5 interface) between UEs or other wireless communication devices.

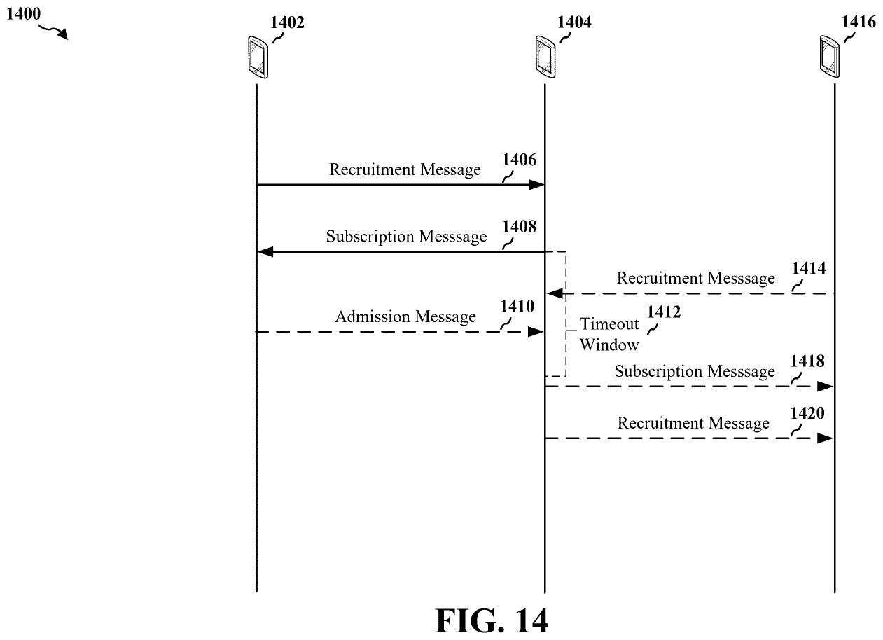

FIG. 11 illustrates an example 1100 of a signaling procedure which allows a first node 1102 (e.g., a UE referred to here as Node 1) to discover potential neighboring nodes such as second node 1104 (e.g., another UE referred to here as Node 2) using sidelink communications. Referring to the previous Figures, Node 1 and Node 2 may be, for example, UE 104, 904, 1002 or network node 706, 802, 852. Initially, first node 1102 may transmit a neighbor discovery (ND) message 1106 or request. The ND message 1106 may be provided periodically (e.g., with a pre-configured periodicity), or in response to an event. For instance, first node 1102 may be triggered to send the ND message 1106 upon receiving a basic safety message (BSM) indicating the existence of another node (e.g., a neighboring VUE). The ND message 1106 may be broadcast in order to solicit a response from any node (e.g., VUEs) capable of decoding the ND message 1106. Alternatively, the ND message 1106 may be groupcast, for example, to nodes which provided a BSM to first node 1102. The ND message 1106 may also be sent using groupcast option 1 to enhance reliability of the ND message 1106 (e.g., first node 1102 may indicate in second stage SCI a distance within which first node 1102 expects to receive NACKs from other nodes who fail to decode the message). In this example, a node which receives the ND message 1106 from first node is referred to here as Node 2 (second node 1104).

In response to receiving the ND message 1106 from first node 1102, second node 1104 may add first node 1102 to a neighbor list, communication graph, or other data structure (stored at second node 1104) indicating first node 1102 is an asymmetric neighbor. Second node 1104 may indicate first node 1102 as an “asymmetric” neighbor since, at this time, second node 1104 is aware of its communication capability with first node 1102, but first node 1102 is not yet aware of its communication capability with second node 1104. Second node 1104 may then provide a neighbor discovery response (NDR) message 1108 acknowledging first node 1102 as an asymmetric neighbor of second node 1104. The NDR message 1108 may be provided unicast to first node 1102. In response to receiving the NDR message 1108, first node 1102 may add second node 1104 to a neighbor list, communication graph, or other data structure (stored at first node 1102) indicating second node 1104 is a symmetric neighbor. First node 1102 may indicate second node 1104 as a “symmetric” neighbor since, at this time, both first node 1102 and second node 1104 are aware of their communication capability with the other node. First node 1102 may then provide second node 1104 a message 1110 (e.g., via unicast) acknowledging second node 1104 as a symmetric neighbor of first node 1102. In response to receiving the message 1110, second node 1104 may update the status of first node 1102 in its data structure to similarly indicate that first node 1102 is now a symmetric neighbor. Second node 1104 may then send a message 1112 to first node 1102 (e.g., via unicast) acknowledging first node 1102 has become a symmetric neighbor of second node 1104.

After first node 1102 and second node 1104 have designated each other as a neighbor (i.e., a symmetric neighbor), first node 1102 may transmit a message 1114 indicating model training-related information to second node 1104. This information may include, for example, ML tasks that first node 1102 is participating in or is interested in participating in, available sensors at first node 1102 and their associated data input format, available ML models in training including model status, model architectures, model training parameters, and current performance (e.g., accuracy and loss), and available computation resources (e.g., whether first node 1102 includes a CPU or GPU, information about its clock speed, available memory, etc.). For instance, the message 1114 may indicate that first node 1102 is configured to perform object detection (e.g., to identify OBBs), image classification, reinforcement learning, or other ML task. The message 1114 may indicate that first node 1102 includes a camera, LIDAR, RADAR, IMU, or other sensor, and data format(s) that are readable by the indicated sensor(s). The message 1114 may indicate that first node 1102 is configured with a neural network (e.g., the CNN of FIG. 6, a DNN, a DCN, a RNN, or other ANN), a quantity of neurons and synapses, a logistic regression or classification model, current values for model weights and biases, an applied activation function (e.g., ReLU), a classification accuracy, and a loss function applied for model weight updates (e.g., a cross-entropy loss function). The message 1114 may indicate that a CPU or GPU of first node 1102 (e.g., controller/processor 459 or some other processor of UE 450) applies the indicated neural network(s) and model(s) for the indicated ML task(s), a clock speed of the CPU or GPU, and a quantity of available memory (e.g., memory 460 or some other memory of UE 450) for storing information associated with the ML task, neural network, data, etc. The message 1114 may include any combination of the foregoing, as well as other information.

In response to receiving message 1114 including the model training-related information, at step 1115, second node 1104 associates this information with first node 1102 in its neighbor list, communication graph, or other data structure. Second node 1104 may consider this information later on during cluster formation if deciding whether or not to form a cluster with first node 1102 to perform a ML task. For example, second node 1104 may determine not to cluster with first node 1102 if this information indicates first node 1102 has a dissimilar ML model or a lower computation capability than that of second node 1104.

Second node 1104 may then send message 1116 indicating model training-related information to first node 1102. This information may include, for example, ML tasks that second node 1104 is participating in or is interested in participating in, available sensors at second node 1104 and their associated data input format, available ML models in training including model status, model architectures, model training parameters, and current performance (e.g., accuracy and loss), and available computation resources (e.g., whether second node 1104 includes a CPU or GPU, information about its clock speed, available memory, etc.). Thus, the message 1116 may include the same type of information as message 1114, but for second node 1104 rather than first node 1102. In response to receiving message 1116 including the model training-related information, at step 1117, first node 1102 associates this information with second node 1104 in its respective data structure. First node 1102 may similarly consider this information later on during cluster formation if deciding whether or not to form a cluster with second node 1104 to perform a ML task.

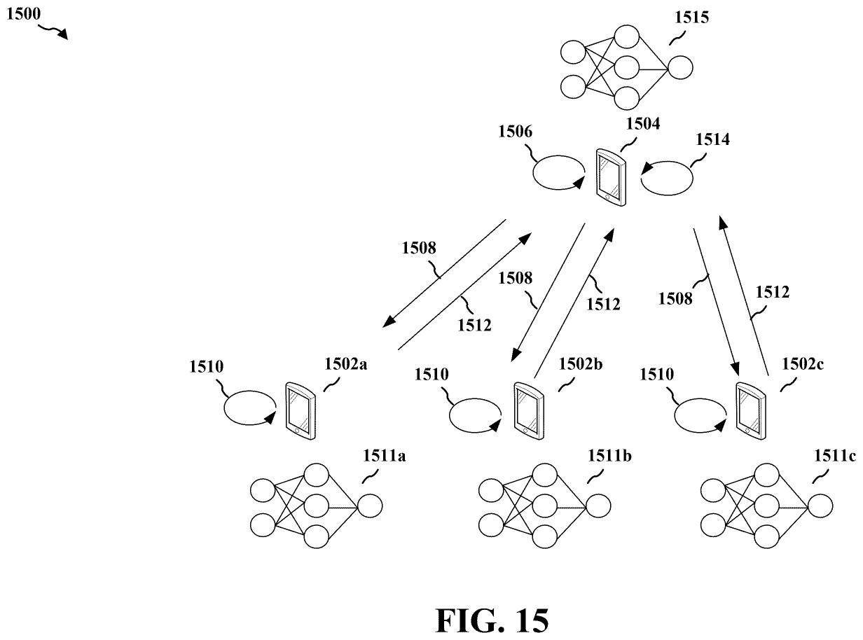

FIG. 12 illustrates an example 1200 of another signaling procedure which allows a first node 1202 (e.g., a UE similarly referred to here as Node 1) to discover potential neighboring nodes such as second node 1204 (e.g., another UE similarly referred to here as Node 2) using sidelink communications. This signaling procedure combines the neighbor discovery and model-related information exchange messages of FIG. 11, thereby resulting in fewer steps but larger message payloads per step than those of the signaling procedure of FIG. 11. Moreover, this signaling procedure allows each node to determine during neighbor discovery whether to add the other node to its neighbor list or similar data structure, in contrast to the signaling procedure of FIG. 11 which postpones such decision making until the cluster formation process.

Initially, first node 1202 may transmit a neighbor discovery (ND) message 1206 or request, similar to that in FIG. 11. In this example, a node which receives the ND message 1206 from first node 1202 is referred to here as second node 1204, similar to the example of FIG. 11. However, in contrast to the example of FIG. 11, in this example the ND message 1206 further indicates model training-related information to second node 1204. This information may include similar types of information as those provided in message 1114 of FIG. 11.

In response to receiving (e.g., successfully decoding) the ND message 1206 from first node 1202, second node 1204 may determine based on the model training-related information in the ND message 1206 whether or not to add first node 1202 to its neighbor list, communication graph, or other data structure. For example, second node 1204 may determine not to add first node 1202 to its data structure if this information indicates first node 1202 has a dissimilar ML model or a lower computation capability than that of second node 1204 (e.g., if first node 1202 is configured with a Markov model or a small amount of available memory for ML while second node 1204 is configured with a classification model or a high amount of available memory for ML). In such case, second node 1204 may disregard or ignore (and thus not respond to) ND message 1206. Alternatively, second node 1204 may determine to add first node 1202 to its data structure if the information indicates, for example, that first node 1202 has a same or similar ML model (e.g., a classification model) or a same or similar computation capability (e.g., memory) as that of second node 1204. In such case, second node 1204 may add first node 1202 and its associated model training-related information to its neighbor list, communication graph, or similar data structure (stored at second node 1204).

Subsequently, second node 1204 may provide an NDR message 1208 to first node 1202 (e.g., via unicast) which not only acknowledges first node 1202 as a neighbor of second node 1204, but also indicates model training-related information of second node 1204. This information may include the same type of information as ND message 1206, but for second node 1204 rather than first node 1202.

In response to receiving the NDR message 1208 including the model training-related information, first node 1202 may similarly determine based on the model training-related information whether or not to add second node 1204 to its neighbor list, communication graph, or other data structure. For example, first node 1202 may determine not to add second node 1204 to its data structure if this information indicates second node 1204 has a dissimilar ML model or a lower computation capability than that of first node 1202. In such case, first node 1202 may disregard or ignore (and thus not respond to) NDR message 1208. Alternatively, first node 1202 may determine to add second node 1204 to its data structure if the information indicates, for example, that second node 1204 has a same or similar ML model or a same or similar computation capability as that of first node 1202. In such case, first node 1202 may add second node 1204 and its associated model training-related information to its neighbor list, communication graph, or similar data structure (stored at first node 1202). Furthermore, first node 1202 may then provide second node 1204 a message 1210 (e.g., via unicast) acknowledging second node 1204 as a neighbor of first node 1202.

On the other hand, if second node 1204 fails to receive, within a pre-configured timeout interval, an acknowledgement of the NDR message 1208 from first node 1202 (or an acknowledgment that second node 1204 has been added to the neighbor list of first node 1202), such as in the case where first node 1202 disregarded or ignored the NDR message 1208, second node 1204 drops first node 1202 and its associated information from its neighbor list, communication graph, or similar data structure. Similarly, as illustrated in the example of FIG. 12, if first node 1202 previously received a ND request 1212 from another node 1214 (third node 1214), sent a NDR message 1216 in response to the ND request 1212, but failed to receive, within a timeout interval 1218, an acknowledgment of the NDR message 1216 from third node 1214 (such as in the case where third node 1214 disregarded or ignored the NDR message 1216) then at step 1220, first node 1202 may discard any associated information of third node 1214 from its neighbor list, communication graph, or similar data structure.

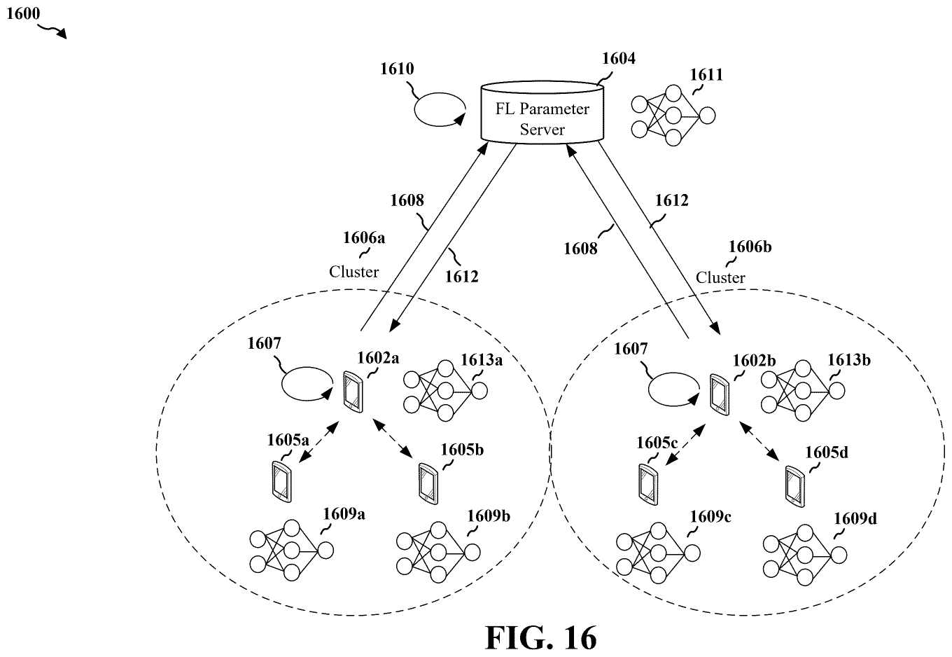

FIG. 13 illustrates an example 1300 of a node state machine during a cluster formation or leader election process. The state machine may indicate a state of a network node (e.g., UE) at a given time and the operations the network node may perform in order to transition between states. Different network nodes may have a similar state machine and operate according to this state machine following the neighbor discovery process of FIG. 11 or 12. A network node which includes at least one other node in its neighbor list, communication graph, or similar data structure may operate according to the node state machine of FIG. 13 in order to form clusters with cluster leaders, or to elect leaders for FL in a peer-to-peer network. Moreover, signaling or communications by a node to its neighbor(s) during this cluster formation or leader election process may be broadcast or groupcast.

In the example of FIG. 13, a network node (e.g., UE) may potentially take on any of the following roles: a leader (aggregator), a follower (participant), or a candidate to be a leader. Leader nodes are configured to aggregate ML model updates from follower nodes in FL for a period of time (a timeout period or term for being a leader). In one example, leader nodes may serve as aggregators without themselves participating in learning or model training, while in other examples, leader nodes may themselves participate in model training in addition to serving as aggregators. Leader nodes may be cluster leaders in a clustered FL architecture such as illustrated in FIG. 9, or peer leaders in a peer-to-peer FL architecture such as illustrated in FIG. 10. Follower nodes are participating or learning nodes in FL which train ML models and provide updates to respective leaders. Candidate nodes are network nodes which contest with other candidate nodes in an election to become a leader node.

Initially, during an election cycle, network nodes begin in a follower state 1302, as illustrated by transition 1304. At this state, a node may change to a candidate state 1306 in response to declaring itself as a candidate for a leader election, as illustrated by transition 1308. In one example of a candidacy trigger, a node may declare itself as a candidate if the node fails to receive a candidacy message (e.g., message 1324 below) from another node within a pre-configured timeout period beginning after the node completes neighbor discovery. This timeout period is intended to provide time for the other node to complete its own neighbor discovery and determine whether to declare itself a candidate before the node makes that determination itself. In another example of a candidacy trigger, even if the node does receive a candidacy message (e.g., message 1324 below) from other node(s) within the pre-configured timeout period, the node may still declare itself as a candidate if the node determines that ML model information collected from the other node(s) during neighbor discovery is insufficient to trigger a vote (e.g., message 1328 below) for election from the node. For instance, the node may disregard such candidacy messages if they originate from nodes including a dissimilar ML model or a lower computation capability than that of the node (e.g., if one node is configured with a Markov model or a small amount of available memory for ML, while the other node is configured with a classification model or a high amount of available memory for ML). In a further example of a candidacy trigger, the node may declare itself as a candidate if, upon completion of neighbor discovery and while monitoring a loss function of its local ML model, the node determines that its loss function indicates a low quality ML model. For instance, if the node determines that the value of its loss function falls below a threshold, the node may be incentivized to be elected as a leader to quickly begin an FL session and improve its loss function. Alternatively, the node may remain in the follower state 1302 in response to taking no action, as illustrated by transition 1310.

During an election, nodes in follower states 1302 may vote on nodes in candidate states 1306 (e.g., based on majority rule). If a candidate node loses the election to another node but still determines to remain a candidate for a subsequent leader election, the node may remain in the candidate state 1306, as illustrated by transition 1312. Alternatively, the node may switch back to the follower state 1302, as illustrated by transition 1314.

On the other hand, if a candidate node wins the election (e.g., the node received a majority vote from other nodes during the election), the node may change to a leader state 1316, as illustrated by transition 1318. During ML model training, this leader node may perform aggregation of model updates from follower nodes in a cluster within a clustered FL architecture, such as described with respect to FIG. 9, or perform aggregation of model updates from follower nodes in a peer-to-peer network having a peer-to-peer FL architecture, such as described with respect to FIG. 10. In a clustered FL architecture, the leader node may also group the follower nodes into a cluster served by the leader node and send a message to the FL parameter server indicating its status as a cluster leader. In either FL architecture, the leader node may remain in the leader state 1316 (as a leader) for a timeout period or term, after which the node may change back to the follower state 1302 as illustrated by transition 1320 and a new leader node may be elected. In the case of a tie where none of the candidate nodes receives a majority vote (e.g., each node receives a same quantity of votes), the follower nodes may select one of the candidate nodes to be a leader node based on various tie-breaking factors. For instance, a leader node may be selected randomly among the tied candidate nodes or selected from whichever candidate node has the most available computation resources or communication qualities (e.g., signal-to-noise ratio) of the tied candidate nodes.

In one example of an election, a candidate node 1322 may groupcast or broadcast a message 1324 indicating its candidacy to other nodes in its neighbor list. Candidate mode 1322 may initially be in a follower node that declared itself as a candidate to be a leader for election in response to any of the aforementioned candidacy triggers. A follower node 1326 that receives this candidacy message, and potentially other candidacy messages from other candidate nodes, may transmit a message 1328 indicating a vote for one of these candidate nodes. Candidate nodes which receive votes from follower nodes may notify other candidate nodes as to the quantity of votes each candidate node has received. If a candidate node has received a majority of votes from follower nodes out of other candidate nodes, or has received a configured or pre-configured quantity of votes exceeding a threshold in the case where a single candidate node is up for election, that node may win the election. This leader node may become a ML model aggregator of a cluster or peer network including the follower nodes that had provided vote messages to that node. The leader node may also send a message 1330 to the follower nodes and the other candidate nodes indicating its status as a leader node for a period of time or term 1332. Once the term 1332 of the leader node ends, the node may send a message 1334 to the follower nodes in its cluster or peer network indicating the end of its term.

In a clustered FL architecture, other elections may simultaneously occur involving other follower nodes and other candidate nodes, and so multiple clusters and cluster leaders may be formed. For instance, one group of follower nodes voting on one group of candidate nodes in their neighbor lists may participate in one cluster while another group of follower nodes voting on another group of candidate nodes in different neighbor lists may participate in a different cluster. In a peer-to-peer FL architecture, the follower nodes and candidate nodes may be within the neighbor lists or network of other follower nodes and candidate nodes, and therefore one peer group and leader may accordingly be formed from these nodes. This result is equivalent to forming a single cluster encompassing every node in a clustered FL architecture (e.g., a peer group may effectively act as a cluster).

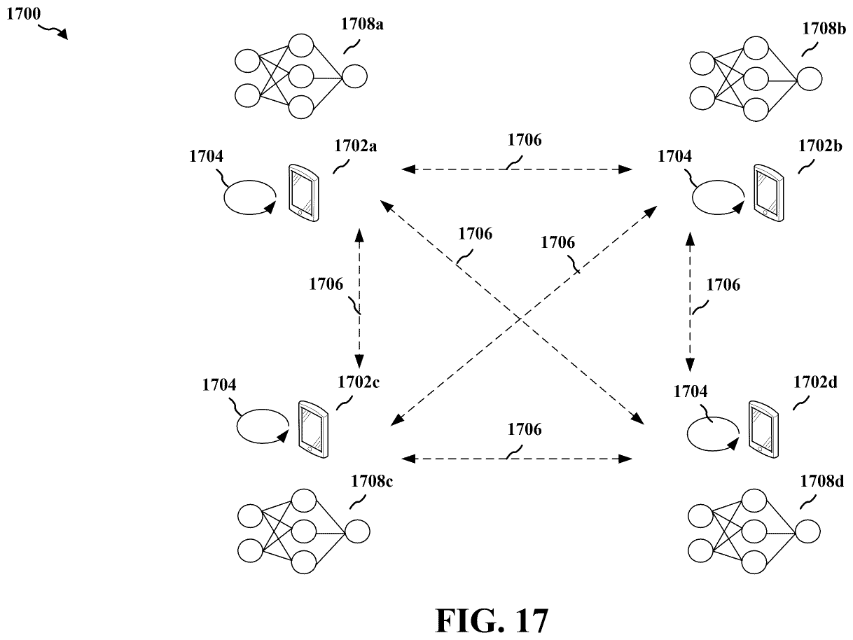

FIG. 14 illustrates an example 1400 of a signaling procedure which allows a first node 1402 (e.g. a UE) to simultaneously discover and form a cluster (as cluster leader in a clustered FL architecture) with a second node 1404 (e.g., another UE) via sidelink communications. This procedure may replace the individual signaling procedures for neighbor discovery and cluster formation described with respect to FIGS. 11-13. In this procedure, network nodes may nominate themselves as cluster leaders (e.g., in response to a nomination trigger discussed below), rather than be elected as cluster leaders by other network nodes. Moreover, a network node intending to serve as a leader (e.g., in response to the nomination trigger) may form a cluster with other network nodes by sending a message to recruit these other nodes to its cluster. This recruitment message may indicate that the network node intends to operate as a cluster leader and FL coordinator as well as indicate ML training-related information of the network node. Examples of nomination triggers may be the same as the examples of candidacy triggers described with respect to FIG. 13. For example, a node may nominate itself as a leader if the node fails to receive a recruitment message (e.g., message 1406 below) from another node within a pre-configured timeout period, if the node determines that ML model information collected from the other node(s) is insufficient to trigger a subscription (e.g., message 1408 below) to its cluster from the node, or if the node determines that its loss function indicates a low quality ML model.

Nodes which receive this recruitment message, and potentially other recruitment messages from other self-nominated leaders, may determine whether or not to subscribe to any of the indicated clusters led by the respective senders based on the indicated ML training-related information in the respective messages. If a network node determines to subscribe to a cluster of one of these sending nodes, the network node may send back a message requesting to subscribe to this cluster and further indicating ML-related training information of this node; otherwise, the network node may ignore the recruitment message. The recruiting node upon receipt of the subscription message may determine whether or not to admit the subscribing node to its cluster similarly based on the indicated ML-related training information of the subscribing node. If an admission decision is made, the recruiting node may send an acknowledgment of cluster admission to the subscribing node. Otherwise, the recruiting node may ignore the subscription message, and the subscribing node may search to join or lead a different cluster after a specified period of time.

Initially, the first node 1402 transmits a message 1406 indicating the first node 1402 is interested in recruiting other nodes to form or join a cluster led by the first node. The message 1406 may be provided periodically (e.g., according to a pre-configured periodicity), for example, if the first node is not currently participating in an active clustered FL session. Alternatively, the message 1406 may be event-triggered, for example, in response to the first node 1402 determining to train or update a ML model to improve performance of a certain ML task. The first node 1402 may broadcast the message 1406 to any network node which is capable of decoding the message. Alternatively, the message 1406 may be groupcast, for example, to network nodes of which the first node 1402 is aware. The message 1406 may also be sent using groupcast option 1 to enhance reliability of the recruitment message (e.g., the first node 1402 may indicate in second stage SCI a distance within which the first node expects to receive NACKs from other nodes who fail to decode the message).

Moreover, the message 1406 may indicate model training-related information of the first node 1402. This information may include, for example, ML tasks that the first node 1402 is participating in or is interested in participating in, available sensors at the first node 1402 and their associated data input format, available ML models in training including model status, model architectures, model training parameters, and current performance (e.g., accuracy and loss), and available computation resources (e.g., whether the first node 1402 includes a CPU or GPU, information about its clock speed, available memory, etc.). Thus, the message 1406 may include similar types of information as those provided in the message 1114 of FIG. 11 or the ND message 1206 of FIG. 12.

In the example of FIG. 14, second node 1404 may receive the message 1406 from the first node 1402 if the nodes are within proximity of each other. The second node 1404 may potentially receive other such messages from other network nodes requesting to recruit the second node 1404 to a cluster led by that respective node. Thus, the second node 1404 may receive recruitment messages from multiple candidates for cluster leadership. In response to receiving the recruitment message(s), the second node may determine whether to subscribe to a cluster of one of these candidates, based at least in part on the model training-related information indicated in the respective messages. This determination may be based on similar factors as those described with respect to FIG. 12 for neighbor lists (e.g., whether the candidate node and the second node have similar ML models, computational resources, etc.).

In this example, the second node 1404 determines to form or join a cluster led by the first node 1402, and so the second node may provide a message 1408 to the first node 1402 (e.g., via unicast) requesting to subscribe to or join with its cluster. This message 1408 may also indicate model training-related information of the second node 1404. This information may include, for example, ML tasks that the second node 1404 is participating in or is interested in participating in, available sensors at the second node and their associated data input format, available ML models in training including model status, model architectures, model training parameters, and current performance (e.g., accuracy and loss), and available computation resources (e.g., whether the second node includes a CPU or GPU, information about its clock speed, available memory, etc.). Thus, the message 1408 may include the same type of information as message 1406, but for the second node 1404 rather than the first node 1402.

In response to receiving the message 1408, the first node 1402 may determine whether or not to admit the second node 1404 to its cluster similarly based at least in part on the model training-related information indicated in the message 1408. For example, the first node 1402 may determine not to add the second node 1404 to its cluster if this information indicates the second node has a dissimilar ML model or a lower computation capability than that of the first node. In such case, the first node 1402 may disregard or ignore (and thus not respond to) message 1408. Alternatively, the first node 1402 may determine to add the second node 1404 to its cluster if the information indicates, for example, that the nodes have a same or similar ML model or a same or similar computation capability. In such case, the first node 1402 may provide (e.g., via unicast) a message 1410 acknowledging admission of the second node 1404 to the cluster led by the first node 1402.

On the other hand, if the first node 1402 determines not to admit the second node 1404 to its cluster, the second node may fail to receive message 1410 within a timeout window 1412 starting from the time that message 1408 was provided (due to the first node 1402 disregarding or ignoring message 1408). In such case, the second node 1404 may subscribe to the cluster of another network node from which the second node previously received a recruitment request. For instance, in the illustrated example of FIG. 14, the second node 1404 may have previously received a message 1414 from a third node 1416 requesting to recruit other nodes to its cluster (similar to message 1406), and based at least in part on model training-related information of the third node 1416 indicated in the message 1414, the second node 1404 may transmit a message 1418 requesting to subscribe to or join the cluster led by the third node 1416 upon expiration of the timeout window 1412. Alternatively, rather than subscribing to the cluster of another network node, the second node 1404 may transmit a message 1420 requesting to recruit other nodes to a cluster led by the second node 1404 (similar to message 1406, 1414). For example, the second node 1404 may determine to nominate itself as a cluster leader and broadcast or groupcast the message 1420 to third node 1416 upon expiration of the timeout window 1412. In response to receiving the message 1420, the third node 1416 may determine whether or not to subscribe to the cluster led by the second node 1404 based on the model training-related information of the second node indicated in message 1420.

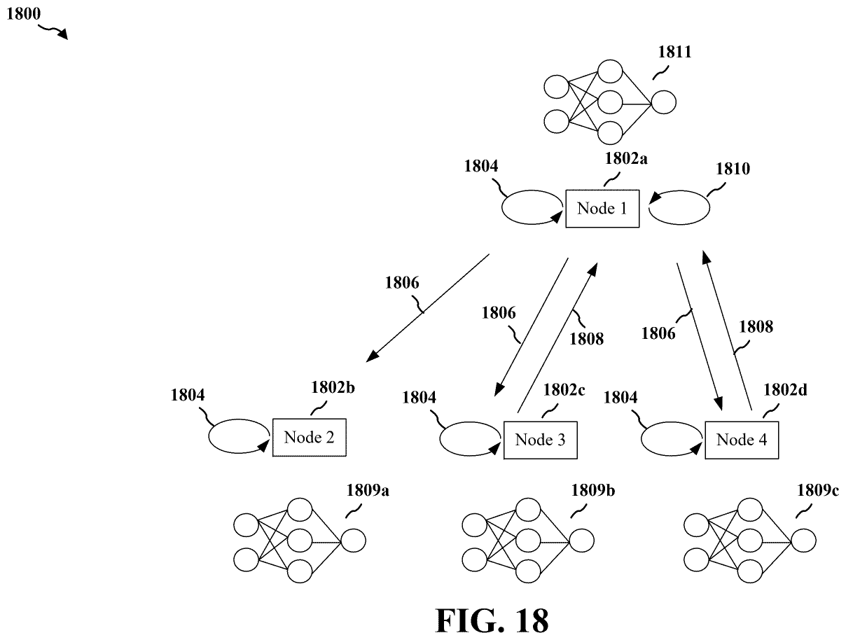

FIG. 15 illustrates an example 1500 of a signaling procedure in which participant nodes 1502 (participant nodes 1502a, 1502b, 1502c) may perform intra-cluster FL or peer-to-peer FL following election or nomination of a leader node 1504 (e.g., a cluster leader or a peer leader) such as described with respect to FIG. 13 or 14. The participant nodes 1502 (e.g., UEs) may be, for example, neighboring follower or candidate nodes in a cluster Ci or a peer-to-peer network. The leader node 1504 (e.g., a UE) may be for example, an elected or self-nominated leader of the cluster Ci or an elected leader of the peer-to-peer network. In one example, leader nodes 1504 may serve as aggregators without themselves participating in learning or model training, while in other examples, leader nodes 1504 may themselves participate in model training in addition to serving as aggregators.

Initially, at step 1506, the leader node 1504 may initialize a ML model (e.g., a cluster model W₀^{Ci} for clustered FL, or a global model W₀^{G} for peer-to-peer FL). The initialization may include, for example, configuring a ML task (e.g., object detection), a neural network (e.g., a CNN), a quantity of neurons and synapses, random weights and biases, a model algorithm (e.g., logistic regression), and other model parameters. Following initialization, at step 1508, the leader node 1504 may broadcast or groupcast these ML model parameters to the network nodes 1502 for download.

Upon receiving the ML model parameters from the leader node 1504 and configuring their local ML models accordingly, at step 1510, the participant nodes 1502 (e.g., k cluster members or peer nodes) and potentially the leader node 1504 may perform local ML model training based on their respective datasets. For instance, during a given FL iteration t, a respective node k (corresponding to cluster model Wₜ^{Cik} or global model Wₜ^{k} depending on the FL architecture) may train a local ML model 1511 (model 1511a, 1511b, 1511c) to identify the optimal model parameters for minimizing a loss function F (Wₜ^{Cik}) or Fₖ (Wₜ^{k}), such as described with respect to FIG. 6. For example, the node may utilize backpropagation and stochastic gradient descent to identify the optimum model weights to be applied to its respective neural network which result in a minimized cross-entropy loss following multiple training sessions. Afterwards, at step 1512, the participant nodes 1502 may upload their respectively updated ML model parameters to the leader node 1504. To reduce transmission traffic, these parameters may include, for example, modified weights, weights that changed more than a threshold, or multiplicative or additive delta amounts or percentages for those weights. For example, the participant nodes 1502 may transmit the optimized ML model weights and other information to the leader node 1504. Following receipt of these ML model information updates from the participant nodes 1502, at step 1514, the leader node 1504 may aggregate the updates to generate an updated ML model 1515 for the nodes (e.g., an updated cluster model Wₜ₊₁^{Ci} or global model Wₜ₊₁^{G} to be applied for the next FL iteration t+1). For example, the leader node 1504 may average or perform some other calculation on the respective model weights indicated by the participant nodes 1502, including potentially the respective model weights of the leader node 1504.

After generating the aggregated ML model information, the leader node 1504 may determine that a loss function associated with the updated ML model is no longer minimized. For example, the aggregated ML model weights may potentially result in increased loss compared to the previous ML model weights for individual nodes. As a result, the leader node may send the aggregated ML model information to the participant nodes 1502, which may be the same nodes as before or may include additional or less nodes, to utilize for further local ML model training. For instance, after configuring their local ML models with the updated weights, during this next FL iteration t−1, the participant nodes 1502 (and potentially the leader node 1504) may again perform local ML model training to arrive at an optimum set of ML model weights for their individual models, and the participant nodes 1502 may similarly send their updated ML models to the leader node 1504 for further aggregation. This process may repeat until a minimization of a loss function associated with the aggregated ML model (e.g., the cluster loss function F(Wₜ^{Ci}) for cluster Ci or the global loss function F_{G} (Wₜ^{G}) for the peer-to-peer network) is achieved. Alternatively, this process may repeat until a predetermined quantity of FL iterations in the cluster or peer-to-peer network has occurred (e.g., a quantity based on the computational capabilities or other ML model information of the participant nodes 1502), or a timeout of the leader node 1504 with respect to its status as a leader has occurred (e.g., if the leader is elected).

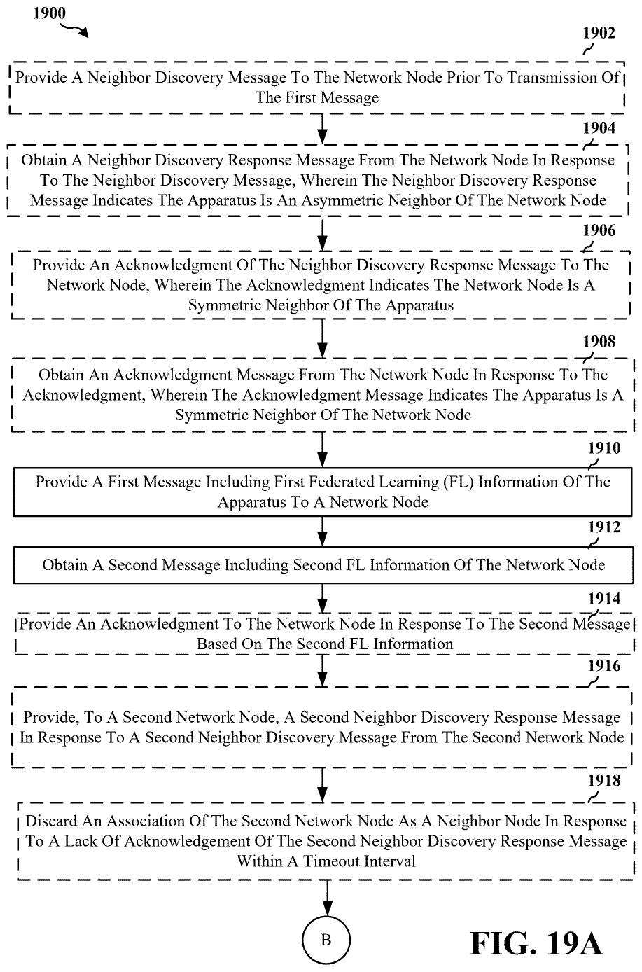

FIG. 16 illustrates an example 1600 of a signaling procedure in which leader nodes 1602 (nodes 1602a, 1602b) may communicate with an FL parameter server 1604 to perform inter-cluster FL following one or more FL iterations of intra-cluster model training with participant nodes 1605 (nodes 1605a, 1605b, 1605c, 1605d) as described with respect to FIG. 15. The leader nodes 1602 (e.g., UEs) may be for example, elected or self-nominated leaders of respective clusters 1606 (clusters 1606a, 1606b). The FL parameter server 1604 may be, for example, a base station, an RSU, or an edge server which coordinates FL between the respective clusters 1606. In one example, leader nodes 1602 may serve as aggregators without themselves participating in learning or model training, while in other examples, leader nodes 1602 may themselves participate in model training in addition to serving as aggregators.

At given instances of time following intra-cluster FL training, the leader nodes 1602 may communicate locally updated ML model information (intra-cluster) to the FL parameter server 1604 for inter-cluster FL training. For example, the FL parameter server 1604 may periodically or aperiodically send requests to cluster leaders to communicate their model updates for inter-cluster FL training. Alternatively, the leader nodes 1602 themselves may communicate their model updates for inter-cluster FL training in response to an event trigger, such as a minimization of a local loss function in a respective cluster or an occurrence of a certain quantity of intra-cluster FL iterations. The FL parameter server 1604 may aggregate this information received from the respective cluster leaders to generate global (multi-cluster) ML model updates, after which the FL parameter server may provide this globally updated ML model information to the respective leader nodes. These leader nodes may in turn provide the globally updated ML model information to their respective participant nodes for further refinement of local ML models through additional intra-cluster FL training. The intra-cluster and inter-cluster FL training may or may not be synchronized; for example, different clusters may perform intra-cluster FL training or inter-cluster FL training over a same quantity or different quantities of iterations before ceasing to perform FL training. For instance, the leader nodes 1602 of respective clusters may stop communicating local model updates (in intra-cluster training) or global model updates (in inter-cluster training) to participating nodes or the FL parameter server simultaneously or at different times.

Initially, at step 1608, the leader node 1602 of a respective cluster may send its updated ML model Wₜ^{Ci} for its cluster Ci, which includes one or more previous aggregations 1607 of ML model updates of local models 1609 (models 1609a, 1609b, 1609c, 1609d) from follower nodes, to the FL parameter server 1604. To reduce transmission traffic, these updates may include, for example, modified weights, weights that changed more than a threshold, or multiplicative or additive delta amounts or percentages for those weights. For instance, the leader node 1602 may send the aggregated ML model weights that it most recently generated after a given quantity of intra-cluster FL iterations, for further aggregation with other aggregated ML model weights generated by other leader nodes in other clusters. The leader node 1602 may be triggered to send the updated ML model for this inter-cluster FL training, for example, in response to receiving a request from the FL parameter server 1604, achieving a minimization of a loss function associated with the updated ML model (e.g., the cluster loss function F(Wₜ^{Ci}) for cluster), an occurrence of a predetermined quantity of FL iterations in the cluster, or a timeout of the leader node 1602 with respect to its status as a leader. Similarly, the leader nodes 1602 of other respective clusters may send their updated ML models (e.g., aggregated ML model weights) respectively for their own clusters to the FL parameter server 1604 for inter-cluster FL training in response to similar events.

After receiving the updated ML models from the cluster leaders, at step 1610, the FL parameter server 1604 may aggregate the updates to generate an updated global ML model 1611 for the leader nodes (e.g., an updated global model Wₜ₊₁^{G}). For example, the FL parameter server 1604 may average or perform some other calculation on the respective, aggregated model weights indicated by the leader nodes 1602. After generating the aggregated ML model information, the FL parameter server 1604 may determine that a global loss function associated with the updated ML model is no longer minimized. For example, the aggregated ML model weights across clusters may potentially result in increased loss compared to the previous updated ML model weights for individual cluster leaders. As a result, at step 1612, the FL parameter server may send the aggregated ML model information to the leader nodes 1602 to utilize for further training of respective intra-cluster ML models 1613 (models 1613a, 1613b, beginning from the updated model Wₜ₊₁^{G}) such as described with respect to FIG. 15. Following this intra-cluster FL training, the leader nodes 1602 may again send their updated or aggregated ML model information to the FL parameter server 1604 for further inter-cluster FL training, and this process may repeat until a minimization of the global loss function associated with the aggregated ML model across clusters (e.g., the global loss function F_{G} (Wₜ^{G})) is achieved. Alternatively, this process may repeat until a predetermined quantity of inter-cluster FL iterations has occurred, or a timeout of the FL parameter server 1604 has occurred (e.g., if the leader is elected).

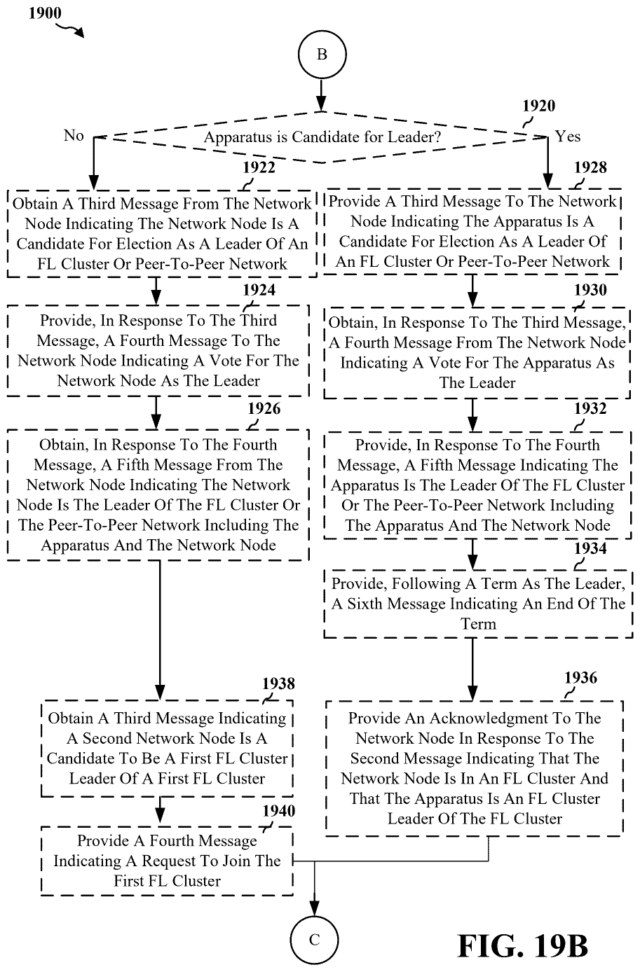

FIG. 17 illustrates an example 1700 of a signaling procedure in which peer nodes 1702 (nodes 1702a, 1702b, 1702c, 1702d) may perform peer-to-peer FL in a synchronized manner without nomination or election of a leader node. The peer nodes 1702 (e.g., UEs) may be, for example, neighboring follower nodes in a peer-to-peer network. Unlike the example of FIG. 15 where participant nodes periodically send model updates to a leader or FL parameter server for aggregation, in this example, the peer nodes 1702 may respectively serve as their own aggregator of ML model updates received from other peer nodes. While this approach may result in peer nodes 1702 performing more computations and experiencing more communication overhead than those in the leader-based approach of FIG. 15, this approach may minimize or avoid aggregation bottlenecks that could otherwise arise in the event of a failure at the leader or FL parameter server (since the peer nodes themselves serve as aggregators). Moreover, this signaling procedure may occur following neighbor discovery such as described with respect to FIGS. 11 and 12, without peer nodes forming clusters or electing leaders as described with respect to FIGS. 13 and 14. As a result, the peer-to-peer network of FIG. 17 may include peer nodes 1702 that communicate with other peer nodes in their respective neighbor lists, effectively within a single group or cluster.

Initially, at step 1704, the peer nodes 1702 may initialize and train their own ML models in parallel using their respective datasets. For instance, a peer node may initialize a ML model, which initialization may include, for example, configuring a ML task (e.g., object detection), a neural network (e.g., a CNN), a quantity of neurons and synapses, random weights and biases, a model algorithm (e.g., logistic regression), and other model parameters. Following initialization, the peer nodes 1702 may perform individual ML model training based on their respective datasets. For instance, a respective node may train its ML model using observed data to identify the optimal model parameters for minimizing a loss function, such as described with respect to FIG. 6. For example, the node may utilize backpropagation and stochastic gradient descent to identify the optimum model weights to be applied to its respective neural network which result in a minimized cross-entropy loss following multiple training sessions or iterations. The training performed by a peer node may continue to occur until a minimization of a loss function associated with the respective ML model is achieved, or until a predetermined quantity of iterations or training sessions has occurred for that peer node.

After the peer nodes 1702 complete or stop their model training, the peer nodes may broadcast their updated ML model information to other peer nodes in their peer-to-peer network (e.g., the nodes in the neighbor lists of respective nodes). To reduce transmission traffic, this information may include, for example, modified weights, weights that changed more than a threshold, or multiplicative or additive delta amounts or percentages for those weights. These broadcasts may be scheduled so that a synchronized model update exchange 1706 may occur between each of the peer nodes 1702. Following this synchronized model update exchange 1706, the peer nodes 1702 may have the updated ML model information (e.g., updated model weights) of other peer nodes as well as their own updated ML model information.

Then, the peer nodes 1702 may respectively aggregate their updates to generate an updated global ML model 1708 (model 1708a, 1708b, 1708c, 1708d) common between the peer nodes. For example, the peer nodes 1702 may average or perform some other common calculation on the model weights that the respective peer node previously obtained during the synchronized model update exchange 1706 including their own updated ML model information. As a result, the aggregated ML model information generated by the peer nodes may be identical. After the peer nodes 1702 generate the aggregated ML model information, the peer nodes may determine that a loss function associated with the updated ML model is no longer minimized, or that a predetermined quantity of FL iterations has not yet occurred. As a result, the peer nodes 1702 may repeat the aforementioned process of performing individual ML training based on their respective datasets, performing a scheduled, synchronized model update exchange, and aggregating the obtained ML model updates from other peer nodes, in a subsequent FL iteration.

Peer nodes may continue to repeat the aforementioned process in multiple FL iterations until a minimization of the loss function associated with the aggregated ML model is finally achieved, an individual target performance metric is met, or a predetermined quantity of FL iterations has occurred. For example, if a peer node determines after one or more FL iterations that a classification accuracy of 75% or more has been achieved, or if the peer node determines that it performed a certain quantity of FL iterations, the peer node may stop performing model training, update exchanges, or aggregation notwithstanding the status of other peer nodes. Thus, other peer nodes seeking a different target performance or a different quantity of FL iterations may continue to perform the aforementioned process until their respective condition(s) are met.

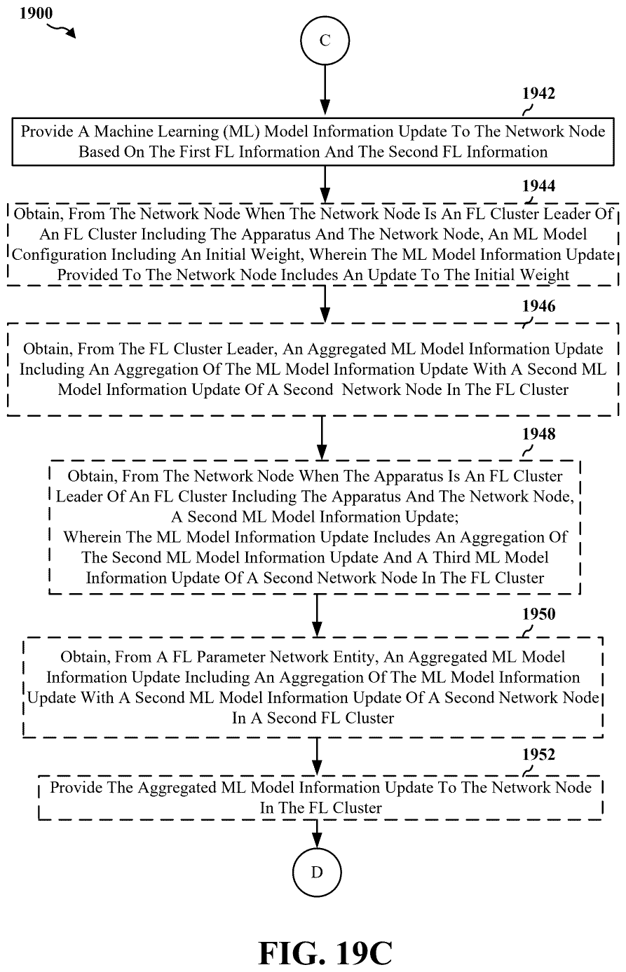

FIG. 18 illustrates an example 1800 of a signaling procedure in which peer nodes 1802 (nodes 1802a, 1802, 1802c, 1802d) may perform peer-to-peer FL in an asynchronized manner without nomination or election of a leader node. The peer nodes 1802 (e.g., UEs) may be, for example, neighboring follower nodes in a peer-to-peer network. Unlike the example of FIG. 15 where participant nodes periodically send model updates to a leader or FL parameter server for aggregation, in this example, the peer nodes 1802 may serve as their own aggregators of ML model updates received from other peer nodes.

Moreover, unlike the example of FIG. 17 where the peer nodes synchronously exchanges model updates with other peer nodes, here the aggregation of model updates by one node is asynchronous with respect to the other nodes. For example, in this procedure, one peer node (e.g., a random node) at a time may request for model updates of other peer nodes and aggregate the model updates to generate an individual updated ML model, rather than multiple peer nodes at the same time. Furthermore, in this example, the requesting peer node may receive model updates having performance metrics specifically meeting a threshold performance level, unlike the example of FIG. 17 where the peer nodes receive model updates from other peer nodes in their neighbor lists notwithstanding model performance. For example, a requesting node may receive model updates specifically from peer nodes having models associated with a classification accuracy above 75% or other threshold, or models associated with some other relatively good performance or evaluation metric. Thus, the requesting peer node may not necessarily receive updates from every peer node in its neighbor list, and the aggregation of model updates may more quickly result in more accurate models compared to the approach of FIG. 17.

Initially, at step 1804, the peer nodes 1802 may initialize and train their own ML models in parallel using their respective datasets. For instance, peer nodes may initialize their respective ML models, which initialization may include, for example, configuring a ML task (e.g., object detection), a neural network (e.g., a CNN), a quantity of neurons and synapses, random weights and biases, a model algorithm (e.g., logistic regression), and other model parameters. Following initialization, the peer nodes 1802 may perform individual ML model training based on their respective datasets. For instance, a respective node may train its ML model using observed data to identify the optimal model parameters for minimizing a loss function, such as described with respect to FIG. 6. The training performed by a peer mode may continue to occur until a minimization of a loss function associated with the respective ML model is achieved, or until a predetermined quantity of iterations or training sessions has occurred for that peer node.

Moreover, while training their respective ML models, the peer nodes 1802 may track a performance metric of their individual ML models. For example, the peer nodes may respectively determine a classification accuracy of their individual models after a predetermined quantity of training sessions has occurred. Alternatively, the peer nodes may determine a logarithmic loss, confusion matrix, or other evaluation metric which indicates the current performance of their respective ML model.

After the peer nodes 1802 complete or stop their model training, at step 1806, one of the peer nodes 1802 (node 1802a or N1 in the illustrated example) sends a request to the other peer nodes for their ML model updates of ML models 1809 (respective ML models 1809a, 1809b, 1809c) during an FL iteration. For example, the peer node sending the request may be a random peer node chosen among the peer nodes 1802 in the network. Peer nodes that receive the request may determine whether to provide their respective ML model update based on their respective performance or evaluation metrics. For instance, if a peer node determines that its performance metric meets a pre-configured threshold (e.g., a classification accuracy of 75% or more), then at step 1808, the peer node may provide its updated ML model information to the requesting node. To reduce transmission traffic, this information may include, for example, modified weights, weights that changed more than a threshold, or multiplicative or additive delta amounts or percentages for those weights. Peer nodes having performance metrics that fall below the pre-configured threshold may in contrast refrain from providing their updated ML model information to the requesting node, or otherwise ignore the request. Thus, in the illustrated example of FIG. 18, N3 (node 1802c) and N4 (node 1802d) have high performance metrics and thus respond with their model updates to N1's (node 1802a's) request, but N2 (node 1802b) has a low performance metric and thus does not respond to the request.

In response to receiving updated ML model information from one or more of the peer nodes 1802 having performance metric(s) meeting the threshold, at step 1810, the requesting peer node (N1 in this example) may aggregate the updates to generate an updated ML model 1811. For example, the requesting peer node may average or perform some other calculation on the model weights that were obtained from the other peer nodes in response to its request. After the requesting peer node obtains the aggregated ML model, the node may determine that a loss function associated with the aggregated ML model is no longer minimized, or that a predetermined quantity of FL iterations has not yet occurred. As a result, the requesting node may continue to perform individual ML training based on its respective dataset until the node is triggered to perform another request in a subsequent FL iteration (e.g., in response to a random selection or other event). Alternatively, if the loss function is minimized or the quantity of FL iterations for that node has occurred, the requesting node may terminate the model training process.

In the meanwhile, after responding to the requesting node (and notwithstanding its subsequent actions), another one of the peer nodes 1802 (node 1802b or N2 in the illustrated example) may send a request to the other peer nodes (including node 1802a or N1) for their respective ML model updates during a subsequent FL iteration. For example, the new peer node sending the request may be another random peer node chosen among the peer nodes 1802 in the network. The peer nodes 1802 that receive the request may similarly provide their model updates depending on their respective performance metrics to the requesting node for ML model aggregation, and the requesting node may similarly continue ML training or terminate ML training based on the loss function, FL iteration quantity, or other factor. This process may similarly repeat for other peer nodes, where peer nodes may individually send requests for model updates at different times while other peer nodes continue to monitor their model performance metrics or quantity of FL iterations.

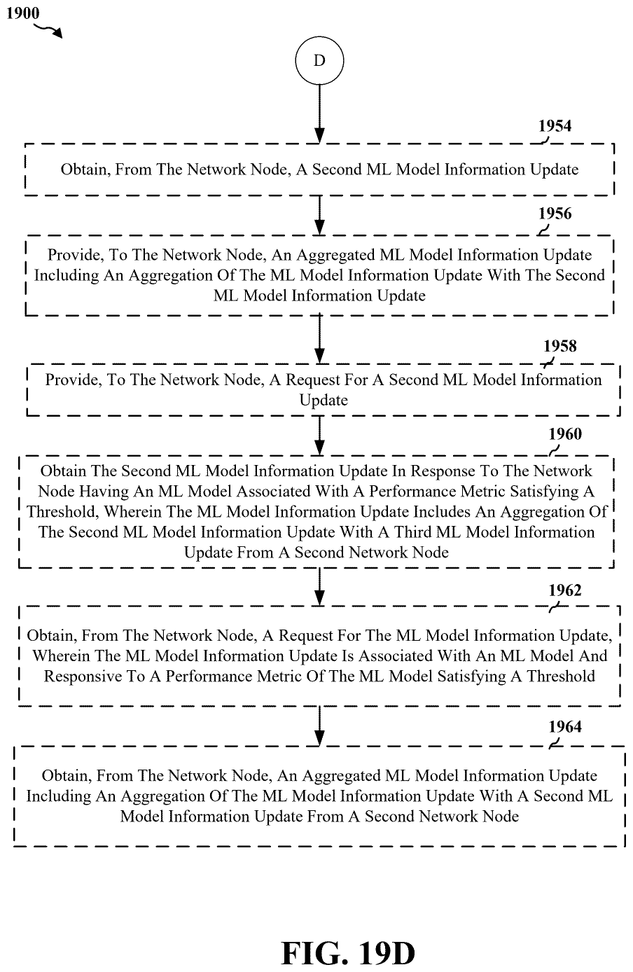

FIGS. 19A-19D are a flowchart 1900 of a method of wireless communication. The method may be performed by a UE (e.g., the UE 104, 904, 1002; device 410, 450; network node 706, 802, 852, 1102, 1104, 1202, 1204, 1402, 1404, 1416, 1502, 1504, 1602, 1605, 1702, 1802; cluster leader 908; leader 1004; the apparatus 2002). For example, the method may be performed by the controller/processor 459, 475 coupled to memory 460, 476 of device 410, 450. Optional aspects are illustrated in dashed lines. The method allows a UE to discover other network nodes (e.g., other UEs) and perform ML model training in a clustered FL or peer-to-peer FL environment through various signaling procedures between the UE and the network node(s).

Referring to FIG. 19A, at 1902, the UE may provide a neighbor discovery message to a network node prior to transmission of a first message (at 1910). For example, 1902 may be performed by neighbor discovery component 2040. For instance, referring to FIG. 11, the first node 1102 (Node 1) may provide ND message 1106 to second node 1104 (Node 2). For example, referring to FIG. 4, the controller/processor 475 in device 410 (e.g., the first node) may provide the first message to device 450 (e.g., the second node) via TX processor 416, which may transmit the first message via antennas 420 to device 450. The ND message 1106 may be provided prior to message 1114 (the first message in this example).

In one example, the UE may provide the neighbor discovery message periodically or in response to an event trigger. For instance, referring to FIG. 11, the first node 1102 may provide ND message 1106 periodically (e.g., with a pre-configured periodicity), or in response to an event. For instance, Node 1 may be triggered to send the ND message 1106 upon receiving a BSM indicating the existence of another node (e.g., a neighboring VUE).

In one example, the UE may provide the neighbor discovery message to the network node in a broadcast or a groupcast. For instance, referring to FIG. 11, the ND message 1106 may be broadcast in order to solicit a response from any node (e.g., VUEs) capable of decoding the ND message. Alternatively, the ND message 1106 may be groupcast, for example, to nodes which provided a BSM to Node 1. The ND message 1106 may also be sent using groupcast option 1 to enhance reliability of the ND message 1106 (e.g., Node 1 may indicate in second stage SCI a distance within which Node 1 expects to receive NACKs from other nodes who fail to decode the message).

At 1904, the UE may obtain a neighbor discovery response message from the network node in response to the neighbor discovery message, where the neighbor discovery response message indicates the UE is an asymmetric neighbor of the network node. For example, 1904 may be performed by neighbor discovery component 2040. For instance in response to receiving the ND message 1106 from Node 1, Node 2 may add Node 1 to a neighbor list, communication graph, or other data structure (stored at Node 2) indicating Node 1 is an asymmetric neighbor. Node 2 may indicate Node 1 as an “asymmetric” neighbor since, at this time, Node B is aware of its communication capability with Node 2, but Node 1 is not yet aware of its communication capability with Node 2. Node 2 may then provide NDR message 1108 (e.g., via unicast) acknowledging Node 1 as an asymmetric neighbor of Node 2. Thus, the first node 1102 may obtain the NDR message 1108 from the second node 1104. For example, referring to FIG. 4, the controller/processor 475 in device 410 may obtain the NDR message from device 450 via RX processor 470, which may receive the NDR message from device 450 via antennas 420.

At 1906, the UE may provide an acknowledgment of the neighbor discovery response message to the network node, where the acknowledgment indicates the network node is a symmetric neighbor of the UE. For example, 1906 may be performed by neighbor discovery component 2040. For instance, referring to FIG. 11, in response to receiving the NDR message 1108, Node 1 may add Node 2 to a neighbor list, communication graph, or other data structure (stored at Node 1) indicating Node 2 is a symmetric neighbor. Node 1 may indicate Node 2 as a “symmetric” neighbor since, at this time, both Node 1 and Node 2 are aware of their communication capability with the other node. Node 1 may then provide Node 2 a message 1110 (e.g., via unicast) acknowledging Node 2 as a symmetric neighbor of Node 1. For example, referring to FIG. 4, the controller/processor 475 in device 410 (e.g., the first node) may provide the acknowledgment to device 450 (e.g., the second node) via TX processor 416, which may transmit the acknowledgment via antennas 420 to device 450.

At 1908, the UE may obtain an acknowledgment message from the network node in response to the acknowledgment, where the acknowledgment message indicates the UE is a symmetric neighbor of the network node. For example, 1908 may be performed by neighbor discovery component 2040. For instance, referring to FIG. 11, in response to receiving the message 1110, Node 2 may update the status of Node 1 in its data structure to similarly indicate that Node 1 is now a symmetric neighbor. Node 2 may then send a message 1112 to Node 1 (e.g., via unicast) acknowledging Node 1 has become a symmetric neighbor of Node 2. Thus, the first node 1102 may obtain the message 1112 from the second node 1104. For example, referring to FIG. 4, the controller/processor 475 in device 410 may obtain the message from device 450 via RX processor 470, which may receive the message from device 450 via antennas 420.

At 1910, the UE provides a first message including first federated learning (FL) information of the apparatus to a network node. For example, 1910 may be performed by neighbor discovery component 2040. The first FL information may comprise at least one of: a machine learning task of the UE, an available sensor coupled to the UE for the machine learning task, an available ML model associated with the machine learning task, or an available computation resource of the UE for the machine learning task. In one example, the first message may be in response to the acknowledgment message obtained at 1908. For instance, referring to FIG. 11, after Node 1 and Node 2 have designated each other as a neighbor (i.e., a symmetric neighbor), Node 1 may transmit a message 1114 (the first message in this example) indicating its model training-related information to Node 2. This information may include, for example, ML tasks that Node 1 is participating in or is interested in participating in, available sensors at Node 1 and their associated data input format, available ML models in training including model status, model architectures, model training parameters, and current performance (e.g., accuracy and loss), or available computation resources (e.g., whether Node 1 includes a CPU or GPU, information about its clock speed, available memory, etc.). The message 1114 may include any combination of the foregoing, as well as other information.

At 1912, the UE obtains a second message including second FL information of the network node. For example, 1912 may be performed by neighbor discovery component 2040. In one example, the second message may be responsive to the first message. For instance, referring to FIG. 11, in response to receiving message 1114 including the model training-related information, Node 2 associates this information with Node 1 in its neighbor list, communication graph, or other data structure. Node 2 may then send message 1116 indicating model training-related information to Node 1. Thus, the first node 1102 may obtain the message 1116 (the second message in this example) from the second node 1104. This information may include, for example, ML tasks that Node 2 is participating in or is interested in participating in, available sensors at Node 2 and their associated data input format, available ML models in training including model status, model architectures, model training parameters, and current performance (e.g., accuracy and loss), and available computation resources (e.g., whether Node 2 includes a CPU or GPU, information about its clock speed, available memory, etc.). Thus, the message 1116 may include the same type of information as message 1114, but for Node 2 rather than Node 1.

In one example, the first message (including the first FL information) may be a neighbor discovery message. For instance, referring to FIG. 12, the first node 1202 (Node 1) may transmit ND message 1206 (the first message in this example) to the second node 1204 (Node 2), similar to that in FIG. 11. However, in contrast to the example of FIG. 11, in this example the ND message 1206 further indicates model training-related information to Node 2. This information may include, for example, ML tasks that Node 1 is participating in or is interested in participating in, available sensors at Node 1 and their associated data input format, available ML models in training including model status, model architectures, model training parameters, and current performance (e.g., accuracy and loss), and available computation resources (e.g., whether Node 1 includes a CPU or GPU, information about its clock speed, available memory, etc.). Thus, the ND message 1206 may include similar types of information as those provided in message 1114 of FIG. 11.

In one example, the second message may be a neighbor discovery response message based on the first FL information. For instance, referring to FIG. 12, in response to receiving (e.g., successfully decoding) the ND message 1206 from Node 1, Node 2 may determine based on the model training-related information in the ND message 1206 whether or not to add Node 1 to its neighbor list, communication graph, or other data structure. For example, Node 2 may determine to add Node A to its data structure if the information indicates, for example, that Node 1 has a same or similar ML model (e.g., a classification model) or a same or similar computation capability (e.g., memory) as that of Node 2. In such case, Node 2 may provide a NDR message 1208 to Node 1 (e.g., via unicast) which not only acknowledges Node 1 as a neighbor of Node 2, but also indicates model training-related information of Node 2. This information may include, for example, ML tasks that Node 2 is participating in or is interested in participating in, available sensors at Node 2 and their associated data input format, available ML models in training including model status, model architectures, model training parameters, and current performance (e.g., accuracy and loss), and available computation resources (e.g., whether Node 2 includes a CPU or GPU, information about its clock speed, available memory, etc.). Thus, the first node 1202 may obtain the NDR message 1208 (the second message in this example) from the second node 1204. The NDR message 1208 may include the same type of information as ND message 1206, but for Node 2 rather than Node 1.

At 1914, the UE may provide an acknowledgment to the network node in response to the second message based on the second FL information. For example, 1914 may be performed by neighbor discovery component 2040. For instance, referring to FIG. 12, in response to receiving the NDR message 1208 including the model training-related information, Node 1 may similarly determine based on the model training-related information whether or not to add Node 2 to its neighbor list, communication graph, or other data structure. For example, Node 1 may determine to add Node 2 to its data structure if the information indicates, for example, that Node 2 has a same or similar ML model or a same or similar computation capability as that of Node 1. In such case, Node 1 may then provide Node 2 a message 1210 (e.g., via unicast) acknowledging Node 2 as a neighbor of Node 1. For example, referring to FIG. 4, the controller/processor 475 in device 410 (e.g., the first node) may provide the acknowledgment (the message 1210) to device 450 (e.g., the second node) via TX processor 416, which may transmit the acknowledgment via antennas 420 to device 450.

At 1916, the UE may provide, to a second network node, a second neighbor discovery response message in response to a second neighbor discovery message from the second network node, and at 1918, the UE may discard an association of the second network node as a neighbor node in response to a lack of acknowledgement of the second neighbor discovery response message within a timeout interval. For example, 1916 and 1918 may be performed by neighbor discovery component 2040. For instance, referring to FIG. 12, before or after providing ND message 1206 to Node 2 and obtaining NDR message 1208 from Node 2, Node 1 may receive ND request 1212 from another node 1214 (Node 3) and send NDR message 1216 in response to the ND request 1212. For example, referring to FIG. 4, controller/processor 475 in device 410 (Node 1 in this example) may obtain the ND request (the second neighbor discovery message) from device 450 (Node C in this example) via RX processor 470, which may receive the ND request from device 450 via antennas 420, and controller/processor 475 may store an indication of device 450 as a neighbor node in its memory 476. Then, controller/processor 475 may provide the NDR message (the second neighbor discovery response message) to device 450 via TX processor 416, which may transmit the NDR message via antennas 420 to device 450. However, if Node 1 fails to receive, within timeout interval 1218, an acknowledgment of the NDR message 1216 from Node 3 (such as in the case where Node 3 disregarded or ignored the NDR message 1216) then at step 1220, Node 1 may discard any associated information of Node 3 from its neighbor list, communication graph, or similar data structure. For example, referring to FIG. 4, controller/processor 475 in device 410 may erase or overwrite in memory 476 the previously stored indication of device 450 (Node 3) as a neighbor node.

Referring to FIG. 19B, at 1920, the flowchart diverges depending on whether the UE is a candidate to be a leader of an FL cluster or peer-to-peer network by election or self-nomination. If the UE is not a candidate for election to be a leader, the UE may perform steps 1922, 1924, and 1926. If the UE is a candidate for election to be a leader, the UE may perform steps 1928, 1930, 1932, and 1934. If the UE is a self-nominated candidate to be a leader, the UE may perform step 1936. If the UE is not a self-nominated candidate to be a leader, the UE may perform steps 1938 and 1940.

At 1922, the UE may obtain a third message from the network node indicating the network node is a candidate for election as a leader of an FL cluster or peer-to-peer network. For example, 1922 may be performed by cluster formation component 2042. For instance, referring to FIG. 13, follower node 1326 (e.g., the UE) may obtain, from candidate node 1322, message 1324 indicating the candidacy of the candidate node 1322. For example, referring to FIG. 4, controller/processor 475 in device 410 (the follower node in this example) may obtain the candidacy message from device 450 (the candidate node in this example) via RX processor 470, which may receive the candidacy message from device 450 via antennas 420. The candidate node 1322 is a network node which contests with other candidate nodes in an election to become a leader node. Leader nodes are configured to aggregate ML model updates from follower nodes in FL for a period of time (a timeout period or term for being a leader). Leader nodes may be cluster leaders in a clustered FL architecture such as illustrated in FIG. 9, or peer leaders in a peer-to-peer FL network or architecture such as illustrated in FIG. 10. The follower node 1326 is a participating or learning node in FL which train ML models and provide updates to respective leaders.

At 1924, the UE may provide, in response to the third message, a fourth message to the network node indicating a vote for the network node as the leader. For example, 1924 may be performed by cluster formation component 2042. For instance, referring to FIG. 13, during an election, nodes in follower states 1302 (e.g., follower node 1326) may vote on nodes in candidate states 1306 (e.g., based on majority rule). Thus, in response to the follower node 1326 receiving the candidacy message, and potentially other candidacy messages from other candidate nodes, the follower node may provide message 1328 indicating a vote for candidate node 1322. For example, referring to FIG. 4, controller/processor 475 may provide the vote message to device 450 (the candidate node) via TX processor 416, which may transmit the vote message via antennas 420 to device 450.

At 1926, the UE may obtain, in response to the fourth message, a fifth message from the network node indicating the network node is the leader of the FL cluster or the peer-to-peer network including the apparatus and the network node. For example, 1926 may be performed by cluster formation component 2042. For instance, referring to FIG. 13, in response to receiving message 1328 from follower node 1326, the candidate node 1322 may receive a majority of votes or a configured or pre-configured quantity of votes exceeding a threshold. Thus, the candidate node may win the election and become a leader node (e.g., via transition 1318). This leader node may become a ML model aggregator of a cluster or peer network including the follower nodes that had provided vote messages to that node. The leader node may also send message 1330 to the follower nodes including follower node 1326 and the other candidate nodes indicating its status as a leader node for a period of time or term 1332. Thus, the follower node (e.g., the UE) may obtain the message 1330 in response to message 1328. For example, referring to FIG. 4, controller/processor 475 in device 410 (the follower node in this example) may obtain the leader message from device 450 (the leader node in this example) via RX processor 470, which may receive the leader message from device 450 via antennas 420.

At 1928, the UE may provide a third message to the network node indicating the apparatus is a candidate for election as a leader of an FL cluster or peer-to-peer network. For example, 1928 may be performed by cluster formation component 2042. For instance, referring to FIG. 13, candidate node 1322 (e.g., the UE) may provide, to follower node 1326, message 1324 indicating the candidacy of the candidate node 1322. For example, referring to FIG. 4, controller/processor 475 may provide the candidacy message to device 450 (the follower node) via TX processor 416, which may transmit the candidacy message via antennas 420 to device 450. The candidate node 1322 is a network node which contests with other candidate nodes in an election to become a leader node. Leader nodes are configured to aggregate ML model updates from follower nodes in FL for a period of time (a timeout period or term for being a leader). Leader nodes may be cluster leaders in a clustered FL architecture such as illustrated in FIG. 9, or peer leaders in a peer-to-peer FL network or architecture such as illustrated in FIG. 10. The follower node 1326 is a participating or learning node in FL which train ML models and provide updates to respective leaders.

At 1930, the UE may obtain, in response to the third message, a fourth message from the network node indicating a vote for the apparatus as the leader. For example, 1930 may be performed by cluster formation component 2042. For instance, referring to FIG. 13, during an election, nodes in follower states 1302 (e.g., follower node 1326) may vote on nodes in candidate states 1306 (e.g., based on majority rule). Thus, in response to the follower node 1326 receiving the candidacy message, and potentially other candidacy messages from other candidate nodes, the candidate node 1322 may obtain message 1328 from the follower node 1326 indicating a vote for candidate node 1322. For example, referring to FIG. 4, controller/processor 475 in device 410 (the candidate node in this example) may obtain the vote message from device 450 (the follower node in this example) via RX processor 470, which may receive the vote message from device 450 via antennas 420.

At 1932, the UE may provide, in response to the fourth message, a fifth message indicating the apparatus is the leader of the FL cluster or the peer-to-peer network including the apparatus and the network node. For example, 1932 may be performed by cluster formation component 2042. For instance, referring to FIG. 13, in response to receiving message 1328 from follower node 1326, the candidate node 1322 may receive a majority of votes or a configured or pre-configured quantity of votes exceeding a threshold. Thus, the candidate node may win the election and become a leader node (e.g., via transition 1318). This leader node may become a ML model aggregator of a cluster or peer network including the follower nodes that had provided vote messages to that node. The leader node may also send message 1330 to the follower nodes including follower node 1326 and the other candidate nodes indicating its status as a leader node for a period of time or term 1332. For example, referring to FIG. 4, controller/processor 475 may provide the leader message to device 450 (the follower node) via TX processor 416, which may transmit the leader message via antennas 420 to device 450.

At 1934, the UE may provide, following a term as the leader, a sixth message indicating an end of the term. For example, 1934 may be performed by cluster formation component 2042. For instance, referring to FIG. 13, the leader node may remain in the leader state 1316 (as a leader) for a timeout period or term, after which the node may change back to the follower state 1302 as illustrated by transition 1320 and a new leader node may be elected. Moreover, once the term 1332 of the leader node ends, the node may send message 1334 to the follower nodes in its cluster or peer network indicating the end of its term. For example, referring to FIG. 4, controller/processor 475 may provide the term end message to device 450 (the follower node) via TX processor 416, which may transmit the term end message via antennas 420 to device 450.

At 1936, the UE may provide an acknowledgment to the network node in response to the second message indicating that the network node is in the FL cluster and that the UE is the FL cluster leader of the FL cluster. For example, 1936 may be performed by cluster formation component 2042. In this example, the first message provided at 1910 may further indicate the UE is a candidate to be an FL cluster leader of an FL cluster, and the second message obtained at 1912 may further include a request from the network node to join the FL cluster. For instance, referring to FIG. 14, initially, the first node 1402 transmits a message 1406 (the first message in this example) indicating the first node 1402 is interested in recruiting other nodes to form or join a cluster led by the first node. The message 1406 may indicate model training-related information of the first node 1402 (e.g., the message 1406 may include similar types of information as those provided in the message 1114 of FIG. 11 or the ND message 1206 of FIG. 12). In response to receiving the recruitment message, the second node 1404 determines to form or join a cluster led by the first node 1402, and so the second node may provide a message 1408 (the second message in this example) to the first node 1402 (e.g., via unicast) requesting to subscribe to or join with its cluster. This message 1408 may also indicate model training-related information of the second node 1404 (e.g., the message 1408 may include the same type of information as message 1406, but for the second node 1404 rather than the first node 1402). In response to receiving the message 1408, the first node 1402 may determine to admit the second node 1404 to its cluster similarly based at least in part on the model training-related information indicated in the message 1408. In such case, the first node 1402 may provide message 1410 acknowledging admission of the second node 1404 to the cluster led by the first node 1402. For example, referring to FIG. 4, controller/processor 475 may provide the acknowledgement message (message 1410) to device 450 (the second node) via TX processor 416, which may transmit the acknowledgement message via antennas 420 to device 450.

At 1938, the UE may obtain a third message indicating a second network node is a candidate to be a first FL cluster leader of a first FL cluster, and at 1940, the UE may provide a fourth message indicating a request to join the first FL cluster. For example, 1938, 1940 may be performed by cluster formation component 2042. In response to a lack of acknowledgment of the fourth message from the second network node within a timeout window, then the first message provided to the network node at 1910 may be requesting to join a second FL cluster or indicating the apparatus is a candidate to be a second FL cluster leader of the second FL cluster. For instance, referring to FIG. 14, the second node 1404 (the UE in this example) may initially obtain message 1406 (the third message in this example) from the first node 1402 (the second network node in this example) indicating its candidacy to be a cluster leader of a cluster (e.g., cluster 902 of FIG. 9), and subsequently provide message 1408 (the fourth message in this example) to the first node 1402 requesting to join its cluster. For example, referring to FIG. 4, controller/processor 475 in device 410 (the UE in this example) may obtain the recruitment message (message 1406) from device 450 (the second network node in this example) via RX processor 470, which may receive the recruitment message from device 450 via antennas 420. The controller/processor 475 may also provide the subscription message (message 1408) to device 450 (the second network node) via TX processor 416, which may transmit the subscription message via antennas 420 to device 450. If the second node 1404 fails to receive message 1410 (the acknowledgement in this example) from the first node 1402 within timeout window 1412, then the second node 1404 may transmit message 1418 (the first message in this example) requesting to subscribe to or join the cluster led by the third node 1416 upon expiration of the timeout window 1412. Alternatively, the second node 1404 may transmit message 1420 (the first message in this other example) requesting to recruit other nodes to a cluster led by the second node 1404 (similar to message 1406, 1414).

Referring to FIG. 19C, at 1942, the UE provides a ML model information update to the network node based on the first FL information and the second FL information. For example, 1942 may be performed by FL training component 2044. In one example, the ML model information update comprises at least one of: a weight, a gradient, or a scaling factor. The scaling factor may be, for example, a multiplicand (e.g., the update may be a multiplicative delta) or a summand (e.g., the update may be an additive delta). For instance, the controller/processor 475 of device 410 (e.g., the UE, which may be, for example, the participant node 1502, leader node 1504, 1602, or peer node 1702, 1802) may provide a ML model information update (e.g., weights 616, biases 618, subsampling or scaling factors in subsampling layers 608, or other updated ML model information following minimization of a loss function) to device 450 (e.g., the network node, which may be, for example, the leader node 1504, 1602, the participant node 1502, or peer node 1702, 1802) via TX processor 416, which may transmit the ML model information update via antennas 420 to device 450. To reduce transmission traffic, this updated ML model information may include, for example, modified weights, weights that changed more than a threshold, or multiplicative or additive delta amounts or percentages for those weights. The UE may provide this update to the network node based on the first FL information that was previously provided in the first message at 1910 and the second FL information that was previously obtained in the second message at 1912. For example, the UE may provide the ML model information update to the aforementioned network node in response to that network node being in a neighbor list, communication graph, or other data structure of the UE following the neighbor discovery process of FIG. 11 or 12 or the simultaneous neighbor discovery and cluster formation process of FIG. 14.

In one example referring to FIG. 15, during a given FL iteration t, a respective node k may train a local ML model 1511 to identify the optimal model parameters (e.g., the weights 616, biases 618, or subsampling factor or other ML model information) for minimizing a loss function F (WtCik) or Fk (Wtk), such as described with respect to FIG. 6. This participant node 1502 (one example of the UE) may then provide these optimized ML model weights and other information (one example of the ML model information update) to the leader node 1504 (one example of the network node) during intra-cluster FL training. Similarly, in another example referring to FIG. 16, a leader node 1602 (another example of the UE) may provide locally updated ML model information (another example of the ML model information update) to the FL parameter server 1604 (another example of the network node) for inter-cluster FL training. Furthermore, after the leader node 1602 obtains from the FL parameter server 1604 globally updated ML model information across clusters, the leader node may provide the globally updated ML model information (another example of the ML model information update) to a respective participant node (another example of the network node) for further refinement of local ML models through additional intra-cluster FL training. Moreover, in another example referring to FIG. 17, peer nodes 1702 (another example of the UE) may provide their updated ML models (another example of the ML model information update) to other peer nodes (another example of the network node) in their peer-to-peer network (e.g., the nodes in the neighbor lists of respective nodes) in a synchronized model update exchange 1706, after which the peer nodes 1702 may have the updated ML model information (e.g., updated model weights) of other peer nodes as well as their own updated ML model information. Similarly, in another example referring to FIG. 18, peer nodes 1802 (another example of the UE) may provide model updates (another example of the ML model information update) having performance metrics specifically meeting a threshold performance level to a requesting peer node (another example of the network node) in an asynchronous manner.

At 1944, the UE may obtain, from the network node when the network node is an FL cluster leader of an FL cluster including the apparatus and the network node, an ML model configuration including an initial weight. For example, 1944 may be performed by FL training component 2044. In this example, the ML model information update provided to the network node at 1942 may include an update to the initial weight. For instance, referring to FIG. 15, the participant node (the UE) may obtain from the leader node 1504 (the network node in this example), at step 1508, ML model parameters initialized by the leader node (at 1506) including a random weight (the initial weight). For example, referring to FIG. 4, controller/processor 475 in device 410 (the UE) may obtain the ML model configuration (the ML model parameters) from device 450 (the leader node) via RX processor 470, which may receive the ML model configuration from device 450 via antennas 420. The leader node 1504 may be for example, an elected or self-nominated leader of a cluster (e.g., cluster 1606 in FIG. 16) including the participant node 1502. Upon receiving the ML model parameters from the leader node 1504 and configuring its local ML model accordingly, at step 1510, the participant node 1502 may perform local ML model training based on its respective dataset such as described with respect to FIG. 6 to identify the optimum model weights to be applied to its respective neural network. Afterwards, at step 1512, the participant node 1502 may provide the optimized ML model weights and other information to the leader node 1504. For instance, referring to FIG. 4, controller/processor 475 in device 410 (the UE) may provide the ML model information update (the optimized ML model weights and other information) to device 450 (the leader node) via TX processor 416, which may transmit the ML model information update via antennas 420 to device 450.

At 1946, the UE may obtain, from the FL cluster leader, an aggregated ML model information update including an aggregation of the ML model information update with a second ML model information update of a second network node in the FL cluster. For example, 1946 may be performed by FL training component 2044. For instance, referring to FIG. 15, the leader node 1504 may aggregate the updates from the participant node 1502 (the UE) and another participant node 1502 in the same cluster (e.g., cluster 1606 of FIG. 16) at step 1514 to generate updated ML model 1515 for the nodes. Afterwards, the leader node 1504 may send this aggregated ML model information (e.g., the averaged or otherwise calculated updated model weights or other information) to the participant nodes to utilize for further local ML model training. Thus, the participant node may obtain from the leader node the aggregated ML model information update. For example, referring to FIG. 4, controller/processor 475 in device 410 (the UE) may obtain the aggregated ML model information update (the aggregated ML model information or updated ML model) from device 450 (the leader node) via RX processor 470, which may receive the aggregated ML model information update from device 450 via antennas 420.

In one example, the aggregated ML model information update may further include a second aggregation of the ML model information update with a third ML model information update of a third network node in a second FL cluster. For instance, referring to FIG. 16, leader nodes 1602 may communicate locally updated ML model information (intra-cluster) to the FL parameter server 1604 for inter-cluster FL training. The FL parameter server 1604 may aggregate this information received from the respective cluster leaders (e.g., in different ones of clusters 1606) to generate global (multi-cluster) ML model updates, after which the FL parameter server may provide this globally updated ML model information to the respective leader nodes. These leader nodes 1602 may in turn provide the globally updated ML model information to their respective participant nodes 1605 for further refinement of local ML models through additional intra-cluster FL training. Thus, when the participant node (the UE) obtains the aggregated ML model information from the leader node (the second network node), this information (the globally updated ML model information) may include the FL parameter server's aggregation (the second aggregation) of the update from the participant node in one of the clusters 1606, with the update from a different participant node (the third network node in this example) in another one of the clusters 1606 (the second FL cluster).

At 1948, the UE may obtain, from the network node when the UE is an FL cluster leader of an FL cluster including the UE and the network node, a second ML model information update, where the ML model information update includes an aggregation of the second ML model information update and a third ML model information update of a second network node in the FL cluster. For example, 1948 may be performed by FL training component 2044. For instance, referring to FIG. 15, at step 1512, the participant nodes 1502 may upload their respectively updated ML model parameters to the leader node 1504. For example, the participant nodes 1502 may transmit the optimized ML model weights and other information to the leader node 1504. Following receipt of these ML model information updates from the participant nodes 1502, at step 1514, the leader node 1504 may aggregate the updates to generate an updated ML model 1515 for the nodes. Thus, the UE (the leader node or leader of cluster 1606 in FIG. 16), may obtain, from a participant node (the network node in this example) in the cluster led by the UE, its respectively updated ML model parameters such as optimized ML model weights and other information (the second ML model information update). Moreover, referring to FIG. 16, the leader nodes 1602 may communicate locally updated ML model information (intra-cluster) to the FL parameter server 1604 for inter-cluster FL training. For instance, at step 1608, the leader node 1602 of a respective cluster may send its updated ML model for its cluster, which includes one or more previous aggregations 1607 of local ML model updates 1609 from follower nodes, to the FL parameter server 1604. Thus, the locally updated ML model information (the ML model information update) that the UE (the leader node) provides (to the FL parameter server) may include an aggregation of the previous aggregations of local ML model updates (including the third ML model information update) of follower or participant nodes (including the network node and the second network node in the FL cluster)

At 1950, the UE may obtain, from a FL parameter network entity when the apparatus is an FL cluster leader of an FL cluster including the apparatus and the network node, an aggregated ML model information update including an aggregation of the ML model information update with a second ML model information update of a second network node in a second FL cluster, and at 1952, the UE may provide the aggregated ML model information update to the network node in the FL cluster. For example, 1950 and 1952 may be performed by FL training component 2044. For instance, referring to FIG. 16, leader nodes 1602 may communicate locally updated ML model information (intra-cluster) to the FL parameter server 1604 for inter-cluster FL training. The FL parameter server 1604 may aggregate this information received from the respective cluster leaders (e.g., in different ones of clusters 1606) to generate global (multi-cluster) ML model updates, after which the FL parameter server may provide this globally updated ML model information to the respective leader nodes. Thus, the leader node (the UE) may obtain, from the FL parameter server (the FL parameter network entity in this example), the globally updated ML model information (the aggregated ML model information update) which includes an aggregation of the locally updated ML model information (the ML model information update provided to the FL parameter server) of the leader node in one cluster with the locally updated ML model information (the second ML model information update) of the leader node in a different cluster (the second network node in the second FL cluster). These leader nodes 1602 may in turn provide the globally updated ML model information to their respective participant nodes 1605 for further refinement of local ML models through additional intra-cluster FL training. Thus, the leader node (the UE) may provide the globally updated ML model information (the aggregated ML model information update) to the participant nodes (including the network node) in its cluster. For instance, controller/processor 475 in device 410 (the UE) may provide the information to device 450 (the network node) via TX processor 416, which may transmit the information via antennas 420 to device 450.

Referring to FIG. 19D, at 1954, the UE may obtain, from the network node, a second ML model information update. For example, 1954 may be performed by FL training component 2044. For instance, referring to FIG. 17, initially, at step 1704, the peer nodes 1702 may initialize and train their own ML models in parallel using their respective datasets. For instance, a respective node may train its ML model using observed data to identify the optimal model parameters for minimizing a loss function, such as described with respect to FIG. 6. After the peer nodes 1702 complete or stop their model training, peer nodes 1702 may broadcast their updated ML models to other peer nodes in their peer-to-peer network (e.g., the nodes in the neighbor lists of respective nodes). These broadcasts may be scheduled so that a synchronized model update exchange 1706 may occur between each of the peer nodes 1702. Thus, the UE (the peer node 1702) may obtain, from the network node (another of the peer nodes 1702), a second ML model information update (the updated ML model of the network node during synchronized model update exchange 1706).

At 1956, the UE may provide, to the network node, an aggregated ML model information update including an aggregation of the ML model information update with the second ML model information update. For example, 1956 may be performed by FL training component 2044. For instance, referring to FIG. 17, following the synchronized model update exchange 1706, the peer nodes 1702 may have the updated ML model information (e.g., updated model weights) of other peer nodes as well as their own updated ML model information. Then, the peer nodes 1702 may respectively aggregate their updates to generate an updated global ML model 1708 common between the peer nodes. For example, the peer nodes 1702 may average or perform some other common calculation on the model weights that the respective peer node previously obtained during the synchronized model update exchange 1706 including their own updated ML model information. After the peer nodes 1702 generate the aggregated ML model information, the peer nodes may determine that a loss function associated with the updated ML model is no longer minimized, or that a predetermined quantity of FL iterations has not yet occurred. As a result, the peer nodes 1702 may repeat the aforementioned process of performing individual ML training based on their respective datasets (at step 1704), performing a scheduled, synchronized model update exchange, and aggregating the obtained ML model updates from other peer nodes, in a subsequent FL iteration. Thus, the UE (the peer node) may provide (during a repetition of the aforementioned process including another synchronized model update exchange), to the network node (the other peer node), an aggregated ML model information update (the aggregated ML model information or updated global ML model 1708) including an aggregation of the ML model information update (the updated ML model trained at step 1704) with the second ML model information update (the updated ML model of the network node during synchronized model update exchange 1706).

At 1958, the UE may provide, to the network node, a request for a second ML model information update. For example, 1958 may be performed by FL training component 2044. For instance, referring to FIG. 18, at step 1806, one of the peer nodes 1802 (N1 in the illustrated example) sends a request to the other peer nodes for their ML model updates during an FL iteration. Thus, the UE (the peer node 1802) may provide, to the network node (one of the other peer nodes), a request (illustrated at step 1806) for a second ML model information update (the ML model update of the other peer node).

At 1960, the UE may obtain the second ML model information update (requested at 1958) in response to the network node having an ML model associated with a performance metric satisfying a threshold. For example, 1960 may be performed by FL training component 2044. For instance, referring to FIG. 18, while training their respective ML models, peer nodes 1802 may track a performance metric of their individual ML models. For example, the peer nodes may respectively determine a classification accuracy of their individual models after a predetermined quantity of training sessions has occurred. Alternatively, the peer nodes may determine a logarithmic loss, confusion matrix, or other evaluation metric which indicates the current performance of their respective ML model. Peer nodes 1802 (e.g., N2, N3, and N4) that afterwards receive the request at step 1806 (e.g., from N1) may determine whether to provide their respective ML model update based on their respective performance or evaluation metrics. For instance, if a peer node determines that its performance metric meets a pre-configured threshold (e.g., a classification accuracy of 75% or more), then at step 1808, the peer node may provide its updated ML model information 1809 to the requesting node. For example, in the illustrated example of FIG. 18, N3 and N4 have high performance metrics and thus respond with their model updates to N1's request. Thus, the UE (the requesting peer node, e.g., N1) may obtain the second ML model information (the respective ML model update or updated ML model information 1809 of the responding peer node, e.g., N3) in response to the network node (the responding peer node, e.g., N3) having an ML model (the individual ML model of the responding peer node) associated with a performance metric (e.g., an evaluation metric such as a classification accuracy) satisfying a threshold (e.g., 75% or more).

In this example, the ML model information update provided at 1942 includes an aggregation of the second ML model information update obtained at 1960 with a third ML model information update from a second network node. For instance, referring to FIG. 18, in response to receiving updated ML model information 1809 from one or more of the peer nodes 1802 having performance metric(s) meeting the threshold (N3 and N4 in the illustrated example), at step 1810, the requesting peer node (N1 in this example) may aggregate the updates to generate an updated ML model 1811. For example, the requesting peer node may average or perform some other calculation on the model weights that were obtained from the other peer nodes in response to its request. After responding to the requesting node, another one of the peer nodes 1802 (N2 in the illustrated example) may send a request to the other peer nodes (including N1) for their respective ML model updates during a subsequent FL iteration. The peer nodes 1802 that receive the request may similarly provide their model updates depending on their respective performance metrics to the requesting node for ML model aggregation. For example, if N1 has a high performance metric, N1 may respond with its model updates (including the previous aggregations). Thus, the ML model information update provided by the UE (the respective ML model updates of the responding peer node, e.g., N1, in response to the request by N2) may include an aggregation of the second ML model information update (e.g., the updated ML model information 1809 from N3) with a third ML model information update from a second network node (e.g., the updated ML model information 1809 from N4).

At 1962, the UE may obtain, from the network node, a request for the ML model information update. For example, 1962 may be performed by FL training component 2044. For instance, referring to FIG. 18, at step 1806, one of the peer nodes 1802 (N1 in the illustrated example) sends a request to the other peer nodes (e.g., N2, N3, and N4) for their ML model updates during an FL iteration. Thus, the UE (the peer node 1802, e.g., N3) may obtain, from the network node (the requesting peer node, e.g., N1), a request (illustrated at step 1806) for the ML model information update (the respective ML model update or updated ML model information 1809 of the responding peer node, e.g., N3).

In this example, the ML model information update is associated with an ML model and responsive to a performance metric of the ML model satisfying a threshold. For instance, referring to FIG. 18, while training their respective ML models, peer nodes 1802 may track a performance metric of their individual ML models. For example, the peer nodes may respectively determine a classification accuracy of their individual models after a predetermined quantity of training sessions has occurred. Alternatively, the peer nodes may determine a logarithmic loss, confusion matrix, or other evaluation metric which indicates the current performance of their respective ML model. Peer nodes 1802 (e.g., N2, N3, and N4) that afterwards receive the request at step 1806 (e.g., from N1) may determine whether to provide their respective ML model update based on their respective performance or evaluation metrics. For instance, if a peer node determines that its performance metric meets a pre-configured threshold (e.g., a classification accuracy of 75% or more), then at step 1808, the peer node may provide its updated ML model information 1809 to the requesting node. For example, in the illustrated example of FIG. 18, N3 and N4have high performance metrics and thus respond with their model updates to N1's request. Thus, the ML model information update provided by the UE (the respective ML model updates of the responding peer node, e.g., N3, in response to the request by N1) is associated with an ML model (e.g., a classification model) and is responsive to a performance metric (e.g., a classification accuracy) of the ML model satisfying a threshold (e.g., 75% or more).

At 1964, the UE may obtain, from the network node, an aggregated ML model information update including an aggregation of the ML model information update with a second ML model information update from a second network node. For example, 1964 may be performed by FL training component 2044. For instance, referring to FIG. 18, in response to receiving updated ML model information 1809 from one or more of the peer nodes 1802 having performance metric(s) meeting the threshold (N3 and N4 in the illustrated example), at step 1810, the requesting peer node (N1 in this example) may aggregate the updates to generate an updated ML model 1811. For example, the requesting peer node may average or perform some other calculation on the model weights that were obtained from the other peer nodes in response to its request. After responding to the requesting node, another one of the peer nodes 1802 (N3 in this example) may send a request to the other peer nodes (including N1) for their respective ML model updates during a subsequent FL iteration. The peer nodes 1802 that receive the request may similarly provide their model updates depending on their respective performance metrics to the requesting node for ML model aggregation. For example, if N1 has a high performance metric, N1 may respond with its model updates (including the previous aggregations). Thus, the UE (e.g., the new requesting peer node here, e.g., N3) may obtain, from the network node (e.g., the new responding peer node here, e.g., N1), an aggregated ML model information update (e.g., the previous aggregation of updated ML model information 1809 of N3 and N4 by N1) including an aggregation of the ML model information update (e.g., the updated ML model information 1809 of N3) with a second ML model information update from a second network node (e.g., the updated ML model information 1809 of N4).

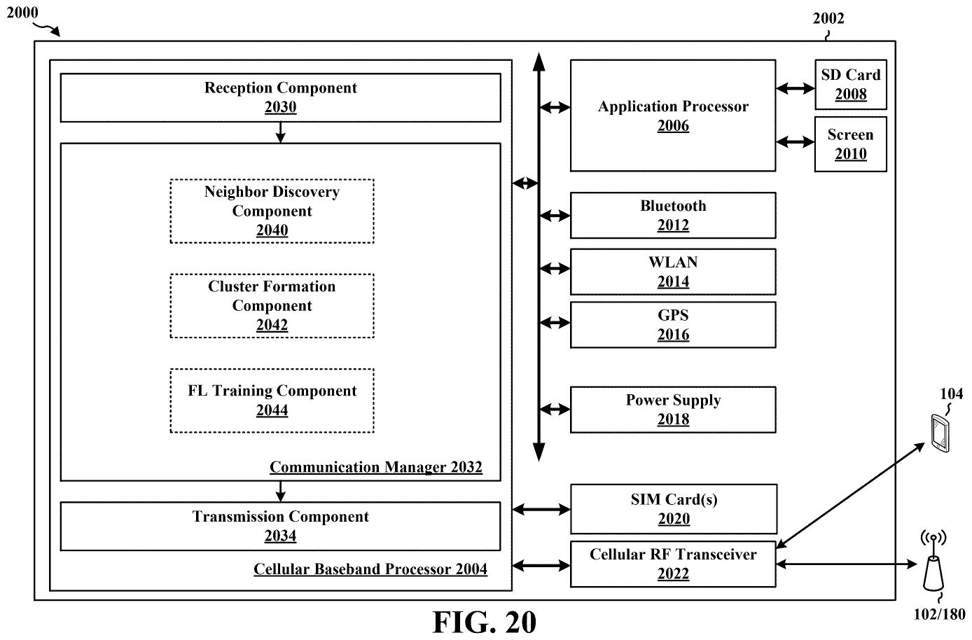

FIG. 20 is a diagram 2000 illustrating an example of a hardware implementation for an apparatus 2002. The apparatus 2002 is a UE and includes a cellular baseband processor 2004 (also referred to as a modem) coupled to a cellular RF transceiver 2022 and one or more subscriber identity modules (SIM) cards 2020, an application processor 2006 coupled to a secure digital (SD) card 2008 and a screen 2010, a Bluetooth module 2012, a wireless local area network (WLAN) module 2014, a Global Positioning System (GPS) module 2016, and a power supply 2018. The cellular baseband processor 2004 communicates through the cellular RF transceiver 2022 with the UE 104 and/or BS 102/180. The cellular baseband processor 2004 may include a computer-readable medium/memory. The computer-readable medium/memory may be non-transitory. The cellular baseband processor 2004 is responsible for general processing, including the execution of software stored on the computer-readable medium/memory. The software, when executed by the cellular baseband processor 2004, causes the cellular baseband processor 2004 to perform the various functions described supra. The computer-readable medium/memory may also be used for storing data that is manipulated by the cellular baseband processor 2004 when executing software. The cellular baseband processor 2004 further includes a reception component 2030, a communication manager 2032, and a transmission component 2034. The communication manager 2032 includes the one or more illustrated components. The components within the communication manager 2032 may be stored in the computer-readable medium/memory and/or configured as hardware within the cellular baseband processor 2004. The cellular baseband processor 2004 may be a component of the device 410, 450 and may include the memory 460, 476 and/or at least one of the TX processor 416, 468, the RX processor 456, 470 and the controller/processor 459, 475. In one configuration, the apparatus 2002 may be a modem chip and include just the baseband processor 2004, and in another configuration, the apparatus 2002 may be the entire UE (e.g., see device 410, 450 of FIG. 4) and include the aforediscussed additional modules of the apparatus 2002.

The communication manager 2032 includes a neighbor discovery component 2040 that is configured to provide a neighbor discovery message to the network node prior to transmission of the first message, e.g., as described in connection with 1902. The neighbor discovery component 2040 is further configured to obtain a neighbor discovery response message from the network node in response to the neighbor discovery message, wherein the neighbor discovery response message indicates the apparatus is an asymmetric neighbor of the network node, e.g., as described in connection with 1904. The neighbor discovery component 2040 is further configured to provide an acknowledgment of the neighbor discovery response message to the network node, wherein the acknowledgment indicates the network node is a symmetric neighbor of the apparatus, e.g., as described in connection with 1906. The neighbor discovery component 2040 is further configured to obtain an acknowledgment message from the network node in response to the acknowledgment, wherein the acknowledgment message indicates the apparatus is a symmetric neighbor of the network node, e.g., as described in connection with 1908. The neighbor discovery component 2040 is further configured to provide a first message including first federated learning (FL) information of the apparatus to a network node, e.g., as described in connection with 1910. The neighbor discovery component 2040 is further configured to obtain a second message including second FL information of the network node, e.g., as described in connection with 1912. The neighbor discovery component 2040 is further configured to provide an acknowledgment to the network node in response to the second message based on the second FL information, e.g., as described in connection with 1914. The neighbor discovery component 2040 is further configured to provide, to a second network node, a second neighbor discovery response message in response to a second neighbor discovery message from the second network node, e.g., as described in connection with 1916. The neighbor discovery component 2040 is further configured to discard an association of the second network node as a neighbor node in response to a lack of acknowledgement of the second neighbor discovery response message within a timeout interval, e.g., as described in connection with 1918.

The communication manager 2032 further includes a cluster formation component 2042 that is configured to obtain a third message from the network node indicating the network node is a candidate for election as a leader of an FL cluster or peer-to-peer network, e.g., as described in connection with 1922. The cluster formation component 2042 is further configured to provide, in response to the third message, a fourth message to the network node indicating a vote for the network node as the leader, e.g., as described in connection with 1924. The cluster formation component 2042 is further configured to obtain, in response to the fourth message, a fifth message from the network node indicating the network node is the leader of the FL cluster or the peer-to-peer network including the apparatus and the network node, e.g., as described in connection with 1926. The cluster formation component 2042 is further configured to provide a third message to the network node indicating the apparatus is a candidate for election as a leader of an FL cluster or peer-to-peer network, e.g., as described in connection with 1928. The cluster formation component 2042 is further configured to obtain, in response to the third message, a fourth message from the network node indicating a vote for the apparatus as the leader, e.g., as described in connection with 1930. The cluster formation component 2042 is further configured to provide, in response to the fourth message, a fifth message indicating the apparatus is the leader of the FL cluster or the peer-to-peer network including the apparatus and the network node, e.g., as described in connection with 1932. The cluster formation component 2042 is further configured to provide, following a term as the leader, a sixth message indicating an end of the term, e.g., as described in connection with 1934. The cluster formation component 2042 is further configured to provide an acknowledgment to the network node in response to the second message indicating that the network node is in an FL cluster and that the apparatus is an FL cluster leader of the FL cluster, e.g., as described in connection with 1936. The cluster formation component 2042 is further configured to obtain a third message indicating a second network node is a candidate to be a first FL cluster leader of a first FL cluster, e.g., as described in connection with 1938. The cluster formation component 2042 is further configured to provide a fourth message indicating a request to join the first FL cluster, e.g., as described in connection with 1940.

The communication manager 2032 further includes a FL training component 2044 that is configured to provide a machine learning (ML) model information update to the network node based on the first FL information and the second FL information, e.g., as described in connection with 1942. The FL training component 2044 is further configured to obtain, from the network node when the network node is an FL cluster leader of an FL cluster including the apparatus and the network node, an ML model configuration including an initial weight, wherein the ML model information update provided to the network node includes an update to the initial weight, e.g., as described in connection with 1944. The FL training component 2044 is further configured to obtain, from the FL cluster leader, an aggregated ML model information update including an aggregation of the ML model information update with a second ML model information update of a second network node in the FL cluster, e.g., as described in connection with 1946. The FL training component 2044 is further configured to obtain, from the network node when the apparatus is an FL cluster leader of an FL cluster including the apparatus and the network node, a second ML model information update, wherein the ML model information update includes an aggregation of the second ML model information update and a third ML model information update of a second network node in the FL cluster, e.g., as described in connection with 1948. The FL training component 2044 is further configured to obtain, from a FL parameter network entity, an aggregated ML model information update including an aggregation of the ML model information update with a second ML model information update of a second network node in a second FL cluster, e.g., as described in connection with 1950. The FL training component 2044 is further configured to provide the aggregated ML model information update to the network node in the FL cluster, e.g., as described in connection with 1952.

The FL training component 2044 is further configured to obtain, from the network node, a second ML model information update, e.g., as described in connection with 1954. The FL training component 2044 is further configured to provide, to the network node, an aggregated ML model information update including an aggregation of the ML model information update with the second ML model information update, e.g., as described in connection with 1956. The FL training component 2044 is further configured to provide, to the network node, a request for a second ML model information update, e.g., as described in connection with 1958. The FL training component 2044 is further configured to obtain the second ML model information update in response to the network node having an ML model associated with a performance metric satisfying a threshold, wherein the ML model information update includes an aggregation of the second ML model information update with a third ML model information update from a second network node, e.g., as described in connection with 1960. The FL training component 2044 is further configured to obtain, from the network node, a request for the ML model information update, wherein the ML model information update is associated with an ML model and responsive to a performance metric of the ML model satisfying a threshold, e.g., as described in connection with 1962. The FL training component 2044 is further configured to obtain, from the network node, an aggregated ML model information update including an aggregation of the ML model information update with a second ML model information update from a second network node, e.g., as described in connection with 1964.

The apparatus may include additional components that perform each of the blocks of the algorithm in the aforementioned flowcharts of FIGS. 19A-19D. As such, each block in the aforementioned flowcharts of FIGS. 19A-19D may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 2002, and in particular the cellular baseband processor 2004, includes means for providing a first message including first federated learning (FL) information of the apparatus to a network node; and means for obtaining a second message including second FL information of the network node; wherein the means for providing is further configured to provide a machine learning (ML) model information update to the network node based on the first FL information and the second FL information.

In one configuration, the ML model information update comprises at least one of: a weight; a gradient; or a scaling factor; and wherein the first FL information comprises at least one of: a machine learning task of the apparatus; an available sensor coupled to the apparatus for the machine learning task; an available ML model associated with the machine learning task; or an available computation resource of the apparatus for the machine learning task; and wherein the apparatus and the network node are user equipment (UEs).

In one configuration, the means for providing is further configured to provide a neighbor discovery message to the network node prior to transmission of the first message.

In one configuration, the means for providing is further configured to provide the neighbor discovery message periodically or in response to an event trigger.

In one configuration, the means for providing is further configured to provide the neighbor discovery message to the network node in a broadcast or a groupcast.

In one configuration, the means for obtaining is further configured to obtain a neighbor discovery response message from the network node in response to the neighbor discovery message, wherein the neighbor discovery response message indicates the apparatus is an asymmetric neighbor of the network node.

In one configuration, the means for providing is further configured to provide an acknowledgment of the neighbor discovery response message to the network node, wherein the acknowledgment indicates the network node is a symmetric neighbor of the apparatus.

In one configuration, the means for obtaining is further configured to obtain an acknowledgment message from the network node in response to the acknowledgment, wherein the acknowledgment message indicates the apparatus is a symmetric neighbor of the network node.

In one configuration, the first message is in response to the acknowledgment message.

In one configuration, the first message is a neighbor discovery message.

In one configuration, the second message is a neighbor discovery response message based on the first FL information.

In one configuration, the means for providing is further configured to provide an acknowledgment to the network node in response to the second message based on the second FL information.

In one configuration, the means for providing is further configured to provide, to a second network node, a second neighbor discovery response message in response to a second neighbor discovery message from the second network node. In one configuration, the apparatus 2002, and in particular the cellular baseband processor 2004, includes means for discarding an association of the second network node as a neighbor node in response to a lack of acknowledgement of the second neighbor discovery response message within a timeout interval.

In one configuration, the means for obtaining is further configured to obtain a third message from the network node, the third message indicating the network node is a candidate for election as a leader of an FL cluster or peer-to-peer network. In one configuration, the means for providing is further configured to provide, in response to the third message, a fourth message to the network node indicating a vote for the network node as the leader. In one configuration, the means for obtaining is further configured to obtain, in response to the fourth message, a fifth message from the network node indicating the network node is the leader of the FL cluster or the peer-to-peer network including the apparatus and the network node.

In one configuration, the means for providing is further configured to provide a third message to the network node indicating the apparatus is a candidate for election as a leader of an FL cluster or peer-to-peer network. In one configuration, the means for obtaining is further configured to obtain, in response to the third message, a fourth message from the network node indicating a vote for the apparatus as the leader. In one configuration, the means for providing is further configured to provide, in response to the fourth message, a fifth message indicating the apparatus is the leader of the FL cluster or the peer-to-peer network including the apparatus and the network node.

In one configuration, the means for providing is further configured to provide, following a term as the leader, a sixth message indicating an end of the term.

In one configuration, the first message further indicates the apparatus is a candidate to be an FL cluster leader of an FL cluster.

In one configuration, the second message further includes a request from the network node to join the FL cluster.

In one configuration, the means for providing is further configured to provide an acknowledgment to the network node in response to the second message indicating that the network node is in the FL cluster and that the apparatus is the FL cluster leader of the FL cluster.

In one configuration, the means for obtaining is further configured to obtain a third message indicating a second network node is a candidate to be a first FL cluster leader of a first FL cluster. In one configuration, the means for providing is further configured to provide a fourth message indicating a request to join the first FL cluster. In one configuration, in response to a lack of acknowledgment of the fourth message from the second network node within a timeout window, the means for providing is further configured to provide the first message to the network node requesting to join a second FL cluster or indicating the apparatus is a candidate to be a second FL cluster leader of the second FL cluster.

In one configuration, the means for obtaining is further configured to obtain, from the network node when the network node is an FL cluster leader of an FL cluster including the apparatus and the network node, an ML model configuration including an initial weight, where the ML model information update provided to the network node includes an update to the initial weight. In one configuration, the means for obtaining is further configured to obtain, from the FL cluster leader, an aggregated ML model information update including an aggregation of the ML model information update with a second ML model information update of a second network node in the FL cluster.

In one configuration, the aggregated ML model information update further includes a second aggregation of the ML model information update with a third ML model information update of a third network node in a second FL cluster.

In one configuration, the means for obtaining is further configured to obtain, from the network node when the apparatus is an FL cluster leader of an FL cluster including the apparatus and the network node, a second ML model information update; where the ML model information update includes an aggregation of the second ML model information update and a third ML model information update of a second network node in the FL cluster.

In one configuration, the means for obtaining is further configured to obtain, from a FL parameter network entity when the apparatus is an FL cluster leader of an FL cluster including the apparatus and the network node, an aggregated ML model information update including an aggregation of the ML model information update with a second ML model information update of a second network node in a second FL cluster. In one configuration, the means for providing is further configured to provide the aggregated ML model information update to the network node in the FL cluster.

In one configuration, the means for obtaining is further configured to obtain, from the network node, a second ML model information update. In one configuration, the means for providing is further configured to provide, to the network node, an aggregated ML model information update including an aggregation of the ML model information update with the second ML model information update.

In one configuration, the means for providing is further configured to provide, to the network node, a request for a second ML model information update. In one configuration, the means for obtaining is further configured to obtain the second ML model information update in response to the network node having an ML model associated with a performance metric satisfying a threshold, where the ML model information update includes an aggregation of the second ML model information update with a third ML model information update from a second network node.

In one configuration, the means for obtaining is further configured to obtain, from the network node, a request for the ML model information update, where the ML model information update is associated with an ML model and responsive to a performance metric of the ML model satisfying a threshold. In one configuration, the means for obtaining is further configured to obtain, from the network node, an aggregated ML model information update including an aggregation of the ML model information update with a second ML model information update from a second network node.

The aforementioned means may be one or more of the aforementioned components of the apparatus 2002 configured to perform the functions recited by the aforementioned means. As described supra, the apparatus 2002 may include the TX processor 416, 468, the RX processor 456, 470 and the controller/processor 459, 475. As such, in one configuration, the aforementioned means may be the TX processor 416, 468, the RX processor 456, 470 and the controller/processor 459, 475 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

The term “receive” and its conjugates (e.g., “receiving” and/or “received,” among other examples) may be alternatively referred to as “obtain” or its respective conjugates (e.g., “obtaining” and/or “obtained,” among other examples). Similarly, the term “transmit” and its conjugates (e.g., “transmitting” and/or “transmitted,” among other examples) may be alternatively referred to as “provide” or its respective conjugates (e.g., “providing” and/or “provided,” among other examples), “generate” or its respective conjugates (e.g., “generating” and/or “generated,” among other examples), and/or “output” or its respective conjugates (e.g., “outputting” and/or “outputted,” among other examples).

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Example 1 is an apparatus for wireless communication, comprising: a processor; memory coupled with the processor, the processor configured to: provide a first message including first federated learning (FL) information of the apparatus to a network node; obtain a second message including second FL information of the network node; and provide a machine learning (ML) model information update to the network node based on the first FL information and the second FL information.

Example 2 is the apparatus of Example 1, wherein the ML model information update comprises at least one of: a weight; a gradient; or a scaling factor, the scaling factor being a multiplicand or a summand; and wherein the first FL information comprises at least one of: a machine learning task of the apparatus; an available sensor coupled to the apparatus for the machine learning task; an available ML model associated with the machine learning task; or an available computation resource of the apparatus for the machine learning task; and wherein the apparatus and the network node are user equipment (UEs).

Example 3 is the apparatus of Examples 1 or 2, wherein the processor is further configured to provide a neighbor discovery message to the network node prior to transmission of the first message.

Example 4 is the apparatus of Example 3, wherein the processor is configured to provide the neighbor discovery message periodically or in response to an event trigger.

Example 5 is the apparatus of Examples 3 or 4, wherein the processor is configured to provide the neighbor discovery message to the network node in a broadcast or a groupcast.

Example 6 is the apparatus of any of Examples 3 to 5, wherein the processor is further configured to obtain a neighbor discovery response message from the network node in response to the neighbor discovery message, wherein the neighbor discovery response message indicates the apparatus is an asymmetric neighbor of the network node.

Example 7 is the apparatus of Example 6, wherein the processor is further configured to provide an acknowledgment of the neighbor discovery response message to the network node, wherein the acknowledgment indicates the network node is a symmetric neighbor of the apparatus.

Example 8 is the apparatus of Example 7, wherein the processor is further configured to obtain an acknowledgment message from the network node in response to the acknowledgment, wherein the acknowledgment message indicates the apparatus is a symmetric neighbor of the network node.

Example 9 is the apparatus of Example 8, wherein the first message is in response to the acknowledgment message.

Example 10 is the apparatus of Examples 1 or 2, wherein the first message is a neighbor discovery message.

Example 11 is the apparatus of Example 10, wherein the second message is a neighbor discovery response message based on the first FL information.

Example 12 is the apparatus of Examples 10 or 11, wherein the processor is further configured to provide an acknowledgment to the network node in response to the second message based on the second FL information.

Example 13 is the apparatus of any of Examples 10 to 12, wherein the processor is further configured to provide, to a second network node, a second neighbor discovery response message in response to a second neighbor discovery message from the second network node, and to discard an association of the second network node as a neighbor node in response to a lack of acknowledgement of the second neighbor discovery response message within a timeout interval.

Example 14 is the apparatus of any of Examples 1 to 13, wherein the processor is further configured to obtain a third message from the network node, the third message indicating the network node is a candidate for election as a leader of an FL cluster or peer-to-peer network; to provide, in response to the third message, a fourth message to the network node indicating a vote for the network node as the leader; and to obtain, in response to the fourth message, a fifth message from the network node indicating the network node is the leader of the FL cluster or the peer-to-peer network including the apparatus and the network node.

Example 15 is the apparatus of any of Examples 1 to 13, wherein the processor is further configured to provide a third message to the network node indicating the apparatus is a candidate for election as a leader of an FL cluster or peer-to-peer network; to obtain, in response to the third message, a fourth message from the network node indicating a vote for the apparatus as the leader; and to provide, in response to the fourth message, a fifth message indicating the apparatus is the leader of the FL cluster or the peer-to-peer network including the apparatus and the network node.

Example 16 is the apparatus of Example 15, wherein the processor is further configured to provide, following a term as the leader, a sixth message indicating an end of the term.

Example 17 is the apparatus of Example 1, wherein the first message further indicates the apparatus is a candidate to be an FL cluster leader of an FL cluster.

Example 18 is the apparatus of Example 17, wherein the second message further includes a request from the network node to join the FL cluster.

Example 19 is the apparatus of Example 18, wherein the processor is further configured to provide an acknowledgment to the network node in response to the second message indicating that the network node is in the FL cluster and that the apparatus is the FL cluster leader of the FL cluster.

Example 20 is the apparatus of any of Examples 17 to 19, wherein the processor is further configured to obtain a third message indicating a second network node is a candidate to be a first FL cluster leader of a first FL cluster; to provide a fourth message indicating a request to join the first FL cluster; and in response to a lack of acknowledgment of the fourth message from the second network node within a timeout window, to provide the first message to the network node requesting to join a second FL cluster or indicating the apparatus is a candidate to be a second FL cluster leader of the second FL cluster.

Example 21 is the apparatus of any of Examples 1 to 20, wherein the processor is further configured to obtain, from the network node when the network node is an FL cluster leader of an FL cluster including the apparatus and the network node, an ML model configuration including an initial weight, where the ML model information update provided to the network node includes an update to the initial weight; and to obtain, from the FL cluster leader, an aggregated ML model information update including an aggregation of the ML model information update with a second ML model information update of a second network node in the FL cluster.

Example 22 is the apparatus of Example 21, wherein the aggregated ML model information update further includes a second aggregation of the ML model information update with a third ML model information update of a third network node in a second FL cluster.

Example 23 is the apparatus of any of Examples 1 to 20, wherein the processor is further configured to obtain, from the network node when the apparatus is an FL cluster leader of an FL cluster including the apparatus and the network node, a second ML model information update; where the ML model information update includes an aggregation of the second ML model information update and a third ML model information update of a second network node in the FL cluster.

Example 24 is the apparatus of any of Examples 1 to 20 or 23, wherein the processor is further configured to obtain, from a FL parameter network entity when the apparatus is an FL cluster leader of an FL cluster including the apparatus and the network node, an aggregated ML model information update including an aggregation of the ML model information update with a second ML model information update of a second network node in a second FL cluster; and to provide the aggregated ML model information update to the network node in the FL cluster.

Example 25 is the apparatus of any of Examples 1 to 20, wherein the processor is further configured to obtain, from the network node, a second ML model information update; and to provide, to the network node, an aggregated ML model information update including an aggregation of the ML model information update with the second ML model information update.

Example 26 is the apparatus of any of Examples 1 to 20, wherein the processor is further configured to provide, to the network node, a request for a second ML model information update; and to obtain the second ML model information update in response to the network node having an ML model associated with a performance metric satisfying a threshold, where the ML model information update includes an aggregation of the second ML model information update with a third ML model information update from a second network node.

Example 27 is the apparatus of any of Examples 1 to 20, wherein the processor is further configured to obtain, from the network node, a request for the ML model information update, where the ML model information update is associated with an ML model and responsive to a performance metric of the ML model satisfying a threshold; and to obtain, from the network node, an aggregated ML model information update including an aggregation of the ML model information update with a second ML model information update from a second network node.

Example 28 is a method of wireless communication at a user equipment (UE), comprising: providing a first message including first federated learning (FL) information of the UE to a network node; receiving a second message including second FL information of the network node; and providing a machine learning (ML) model information update to the network node based on the first FL information and the second FL information.

Example 29 is an apparatus for wireless communication, comprising: means for providing a first message including first federated learning (FL) information of the apparatus to a network node; means for obtaining a second message including second FL information of the network node; and wherein the means for providing is further configured to provide a machine learning (ML) model information update to the network node based on the first FL information and the second FL information.

Example 30 is a non-transitory computer-readable medium storing computer executable code, the code when executed by a processor cause the processor to: provide a first message including first federated learning (FL) information to a network node; obtain a second message including second FL information of the network node; and provide a machine learning (ML) model information update to the network node based on the first FL information and the second FL information.

What is claimed is:

1. An apparatus for wireless communication, comprising:
a processor;
memory coupled with the processor, the processor configured to:
provide a first message including first federated learning (FL) information of the apparatus to a network node;
obtain a second message including second FL information of the network node; and
provide a machine learning (ML) model information update to the network node based on the first FL information and the second FL information.

2. The apparatus of claim 1,
wherein the ML model information update comprises at least one of:
a weight;
a gradient; or
a scaling factor, the scaling factor being a multiplicand or a summand;
and
wherein the first FL information comprises at least one of:
a machine learning task of the apparatus;
an available sensor coupled to the apparatus for the machine learning task;
an available ML model associated with the machine learning task; or
an available computation resource of the apparatus for the machine learning task;
and
wherein the apparatus and the network node are user equipment (UEs).

3. The apparatus of claim 1, wherein the processor is further configured to:
provide a neighbor discovery message to the network node prior to transmission of the first message.

4. The apparatus of claim 3, wherein the processor is configured to provide the neighbor discovery message periodically or in response to an event trigger.

5. The apparatus of claim 3, wherein the processor is configured to provide the neighbor discovery message to the network node in a broadcast or a groupcast.

6. The apparatus of claim 3, wherein the processor is further configured to:
obtain a neighbor discovery response message from the network node in response to the neighbor discovery message, wherein the neighbor discovery response message indicates the apparatus is an asymmetric neighbor of the network node.

7. The apparatus of claim 6, wherein the processor is further configured to:
provide an acknowledgment of the neighbor discovery response message to the network node, wherein the acknowledgment indicates the network node is a symmetric neighbor of the apparatus.

8. The apparatus of claim 7, wherein the processor is further configured to:
obtain an acknowledgment message from the network node in response to the acknowledgment, wherein the acknowledgment message indicates the apparatus is a symmetric neighbor of the network node.

9. The apparatus of claim 8, wherein the first message is in response to the acknowledgment message.

10. The apparatus of claim 1, wherein the first message is a neighbor discovery message.

11. The apparatus of claim 10, wherein the second message is a neighbor discovery response message based on the first FL information.

12. The apparatus of claim 10, wherein the processor is further configured to:
provide an acknowledgment to the network node in response to the second message based on the second FL information.

13. The apparatus of claim 1, wherein the processor is further configured to:
provide, to a second network node, a second neighbor discovery response message in response to a second neighbor discovery message from the second network node; and
discard an association of the second network node as a neighbor node in response to a lack of acknowledgement of the second neighbor discovery response message within a timeout interval.

14. The apparatus of claim 1, wherein the processor is further configured to:
obtain a third message from the network node, the third message indicating the network node is a candidate for election as a leader of an FL cluster or peer-to-peer network;
provide, in response to the third message, a fourth message to the network node indicating a vote for the network node as the leader; and
obtain, in response to the fourth message, a fifth message from the network node indicating the network node is the leader of the FL cluster or the peer-to-peer network including the apparatus and the network node.

15. The apparatus of claim 1, wherein the processor is further configured to:
provide a third message to the network node indicating the apparatus is a candidate for election as a leader of an FL cluster or peer-to-peer network;
obtain, in response to the third message, a fourth message from the network node indicating a vote for the apparatus as the leader; and
provide, in response to the fourth message, a fifth message indicating the apparatus is the leader of the FL cluster or the peer-to-peer network including the apparatus and the network node.

16. The apparatus of claim 15, wherein the processor is further configured to:
provide, following a term as the leader, a sixth message indicating an end of the term.

17. The apparatus of claim 1, wherein the first message further indicates the apparatus is a candidate to be an FL cluster leader of an FL cluster.

18. The apparatus of claim 17, wherein the second message further includes a request from the network node to join the FL cluster.

19. The apparatus of claim 18, wherein the processor is further configured to:
provide an acknowledgment to the network node in response to the second message indicating that the network node is in the FL cluster and that the apparatus is the FL cluster leader of the FL cluster.

20. The apparatus of claim 1, wherein the processor is further configured to:
obtain a third message indicating a second network node is a candidate to be a first FL cluster leader of a first FL cluster; and
provide a fourth message indicating a request to join the first FL cluster;
wherein in response to a lack of acknowledgment of the fourth message from the second network node within a timeout window, the processor is configured to provide the first message to the network node requesting to join a second FL cluster or indicating the apparatus is a candidate to be a second FL cluster leader of the second FL cluster.

21. The apparatus of claim 1, wherein the processor is further configured to:
obtain, from the network node when the network node is an FL cluster leader of an FL cluster including the apparatus and the network node, an ML model configuration including an initial weight;
wherein the ML model information update provided to the network node includes an update to the initial weight; and
obtain, from the FL cluster leader, an aggregated ML model information update including an aggregation of the ML model information update with a second ML model information update of a second network node in the FL cluster.

22. The apparatus of claim 21, wherein the aggregated ML model information update further includes a second aggregation of the ML model information update with a third ML model information update of a third network node in a second FL cluster.

23. The apparatus of claim 1, wherein the processor is further configured to:
obtain, from the network node when the apparatus is an FL cluster leader of an FL cluster including the apparatus and the network node, a second ML model information update;
wherein the ML model information update includes an aggregation of the second ML model information update and a third ML model information update of a second network node in the FL cluster.

24. The apparatus of claim 1, wherein the processor is further configured to:
obtain, from a FL parameter network entity when the apparatus is an FL cluster leader of an FL cluster including the apparatus and the network node, an aggregated ML model information update including an aggregation of the ML model information update with a second ML model information update of a second network node in a second FL cluster; and
provide the aggregated ML model information update to the network node in the FL cluster.

25. The apparatus of claim 1, wherein the processor is further configured to:
obtain, from the network node, a second ML model information update; and
provide, to the network node, an aggregated ML model information update including an aggregation of the ML model information update with the second ML model information update.

26. The apparatus of claim 1, wherein the processor is further configured to:
provide, to the network node, a request for a second ML model information update;
obtain the second ML model information update in response to the network node having an ML model associated with a performance metric satisfying a threshold; and
wherein the ML model information update includes an aggregation of the second ML model information update with a third ML model information update from a second network node.

27. The apparatus of claim 1, wherein the processor is further configured to:
obtain, from the network node, a request for the ML model information update;
wherein the ML model information update is associated with an ML model and responsive to a performance metric of the ML model satisfying a threshold; and
obtain, from the network node, an aggregated ML model information update including an aggregation of the ML model information update with a second ML model information update from a second network node.

28. A method of wireless communication at a user equipment (UE), comprising:
providing a first message including first federated learning (FL) information of the UE to a network node;
obtaining a second message including second FL information of the network node; and
providing a machine learning (ML) model information update to the network node based on the first FL information and the second FL information.

29. An apparatus for wireless communication, comprising:
means for providing a first message including first federated learning (FL) information of the apparatus to a network node;
means for obtaining a second message including second FL information of the network node; and
wherein the means for providing is further configured to provide a machine learning (ML) model information update to the network node based on the first FL information and the second FL information.

30. A non-transitory computer-readable medium storing computer executable code, the code when executed by a processor cause the processor to:
provide a first message including first federated learning (FL) information to a network node;
obtain a second message including second FL information of the network node; and
provide a machine learning (ML) model information update to the network node based on the first FL information and the second FL information.
